(19) United States
(12) Patent Application Publication
(10) Pub. No.: US 2025/0111978 A1
(43) Pub. Date: Apr. 3, 2025

(54) INDUCTOR

(71) Applicant: Murata Manufacturing Co., Ltd., Kyoto-fu (JP)

(72) Inventors: Atsushi SEKO, Nagaokakyo-shi (JP); Seiya KIKUCHI, Nagaokakyo-shi (JP)

(73) Assignee: Murata Manufacturing Co., Ltd., Kyoto-fu (JP)

(21) Appl. No.: 18/903,861

(22) Filed: Oct. 1, 2024

(30) Foreign Application Priority Data
Oct. 2, 2023 (JP) 2023-171266

(51) Int. Cl. H01F 17/00; H01F 27/29

(52) U.S. Cl. CPC H01F 17/0013; H01F 27/292; H01F 2017/002

(57) ABSTRACT

An inductor including a component main body having a multilayer structure formed with stacked non-conductive material layers; and a coil inside the component main body and configured of line conductors each extending along an interface between the non-conductive material layers and via conductors penetrating through the non-conductive material layers to a thickness direction. The line conductors each have pad portions connected to the via conductors and line wire portions connected to the pad portions. The coil has a shape of extending along a helical path with the line conductors and the via conductors alternately connected, in which the via conductors include a longitudinal via conductor in a longitudinal shape extending along the line conductor. The pad portions include a longitudinal pad portion connected to the longitudinal via conductor, and a width-direction dimension of the longitudinal pad portion is larger than a width-direction dimension of the line wire portion.

### CROSS-REFERENCE TO RELATED APPLICATION

This application claims benefit of priority to Japanese Patent Application No. 2023-171266, filed Oct. 2, 2023, the entire content of which is incorporated herein by reference.

### BACKGROUND

### Technical Field

The present disclosure relates to an inductor.

### Background Art

To improve the Q factor (Q characteristics), which is a characteristic index of an inductor, it is desired not to block a magnetic flux occurring inside a coil in a shape of extending along a helical path configured of a line conductor and a via conductor (including a longitudinal via conductor) alternately connected to each other. For example, in Japanese Unexamined Patent Application Publication No. 2023-47357, a structure is disclosed in which the longitudinal via conductor is shifted not only to an inner circumferential side but also to an outer circumferential side of the helical path to reduce the degree of projection of the longitudinal via conductor (refer to FIG. 13).

### SUMMARY

However, even if the longitudinal via conductor is shifted as in this case, it has become impossible to obtain a sufficient improvement in the Q factor. In particular, with demands for lower-profile, smaller-sized inductors in recent years, this trend has become significant. The reason for this is as follows. The longitudinal via conductor has a long length in its longitudinal direction, and the via conductor is a conductor connected to a stacking direction and it is thus difficult to suppress the thick thickness in the stacking direction. Also, in view of suppression of a short circuit between line conductors, the thickness in the stacking direction is suitable. Thus, when the longitudinal via conductor is shifted to the inner circumferential side of the helical path, influences of blocking the magnetic flux passing through the inside of the coil are large, and there is a possibility of being incapable of suppressing degradation in Q characteristics.

Accordingly, the present disclosure provides an inductor capable of improving the Q characteristics.

In a first aspect, an inductor of the present disclosure includes a component main body having a multilayer structure formed with a plurality of stacked non-conductive material layers; and a coil arranged inside the component main body and configured of a plurality of line conductors each extending along an interface between the non-conductive material layers and a plurality of via conductors penetrating through the non-conductive material layers to a thickness direction. The line conductors each have pad portions connected to the via conductors and line wire portions connected to the pad portions. The coil has a shape of extending along a helical path with the line conductors and the via conductors alternately connected. The via conductors include a longitudinal via conductor in a longitudinal shape extending along the line conductor. The pad portions include a longitudinal pad portion connected to the longitudinal via conductor. A width-direction dimension of the longitudinal pad portion is larger than a width-direction dimension of the line wire portion. When seen through to an axial direction of the coil, a center position of the longitudinal pad portion in a width direction is shifted from a center position of the line wire portion in the width direction to at least one of an inner circumferential side and an outer circumferential side of the helical path.

In a second aspect, an inductor of the present disclosure includes a component main body having a multilayer structure formed with a plurality of stacked non-conductive material layers; and a coil arranged inside the component main body and configured of a plurality of line conductors each extending along an interface between the non-conductive material layers and a plurality of via conductors penetrating through the non-conductive material layers to a thickness direction. The line conductors each have pad portions connected to the via conductors and line wire portions connected to the pad portions. The coil having a shape of extending along a helical path with the line conductors and the via conductors alternately connected. The via conductors include a longitudinal via conductor in a longitudinal shape extending along the line conductor. The pad portions include a longitudinal pad portion connected to the longitudinal via conductor. The longitudinal pad portion includes a non-uniform pad portion with a non-uniform width-direction dimension. A maximum value of the width-direction dimension of the non-uniform pad portion is larger than a width-direction dimension of the line wire portion. A minimum value of the width-direction dimension of the non-uniform pad portion is larger than or equal to the width-direction dimension of the line wire portion. Of the non-uniform pad portion, a center position in a width direction of a portion having a width-direction dimension larger than the width-direction dimension of the line wire portion is shifted from a center position of the line wire portion in the width direction to an outer circumferential side of the helical path.

In a third aspect, an inductor of the present disclosure includes a component main body having a multilayer structure formed with a plurality of stacked non-conductive material layers; a coil arranged inside the component main body and configured of a plurality of line conductors each extending along an interface between the non-conductive material layers and a plurality of via conductors penetrating through the non-conductive material layers to a thickness direction, the line conductors each having pad portions connected to the via conductors and line wire portions connected to the pad portions, the coil having a shape of extending along a helical path with the line conductors and the via conductors alternately connected; and an outer terminal electrode provided so as to be exposed from an outer surface of the component main body and connected to any end of the coil. The via conductors include a longitudinal via conductor in a longitudinal shape extending along the line conductor. The pad portions include a longitudinal pad portion connected to the longitudinal via conductor. The component main body has a rectangular-parallelepiped shape and has a mount surface, a top surface opposed to the mount surface, a first side surface and a second side surface coupling the mount surface and the top surface together and opposed to each other, and a first end surface and a second end surface coupling the mount surface and the top surface together and coupling the first side surface and the second side surface together and opposed to each other. An axial line of the coil is oriented to a direction orthogonal to the mount surface. A width-direction dimension of the longitudinal pad portion is larger than a width-direction dimension of the line wire portion. When a shortest distance between a surface of the component main body and an outer circumferential edge of the line wire portion is set as D, of the longitudinal pad portion, a center position in a width direction of a portion in which a space from an inner end surface of the outer terminal electrode or the surface of the component main body is smaller than or equal to D is shifted from a center position of the line wire portion in the width direction to an inner circumferential side of the helical path, and, of the longitudinal pad portion, a center position in the width direction of a portion in which the space from the inner end surface of the outer terminal electrode or the surface of the component main body is larger than D is shifted from the center position of the line wire portion in the width direction to an outer circumferential side of the helical path.

In a fourth aspect, an inductor of the present disclosure includes: a component main body having a multilayer structure formed with a plurality of stacked non-conductive material layers; and a coil arranged inside the component main body and configured of a plurality of line conductors each extending along an interface between the non-conductive material layers and a plurality of via conductors penetrating through the non-conductive material layers to a thickness direction. The line conductors each have pad portions connected to the via conductors and line wire portions connected to the pad portions. The coil has a shape of extending along a helical path with the line conductors and the via conductors alternately connected. The via conductors include a longitudinal via conductor in a longitudinal shape extending along the line conductor. The pad portions include a longitudinal pad portion connected to the longitudinal via conductor. A width-direction dimension of the longitudinal pad portion is larger than a width-direction dimension of the line wire portion. The line wire portion includes a line-symmetric line wire portion having a line-symmetric shape. The longitudinal pad portion connected to the line-symmetric line wire portion includes a third portion and a fourth portion sequentially arranged to a direction in which the line conductor extends. When a portion obtained by folding the line-symmetric line wire portion along a symmetry axis to the third portion and the fourth portion is set as a virtual line wire portion, an inner circumferential edge of the third portion is positioned on an inner circumferential edge of the virtual line wire portion, an outer circumferential edge of the third portion protrudes from an outer circumferential edge of the virtual line wire portion, an inner circumferential edge of the fourth portion protrudes from the inner circumferential edge of the virtual line wire portion, and an outer circumferential edge of the fourth portion is positioned on the outer circumferential edge of the virtual line wire portion.

According to the present disclosure, an inductor capable of improving the Q characteristics can be provided.

### BRIEF DESCRIPTION OF THE DRAWINGS

FIG. 1 is a perspective view depicting the outer appearance of an inductor 11 according to a first embodiment of the present disclosure;

FIG. 2 is a view of the inductor 11 depicted in FIG. 1 seen through to an axial direction of a coil 20;

FIG. 3 depicts part of the inductor 11 depicted in FIG. 2, and is a plan view depicting a non-conductive material layer 19-1 provided with a line conductor 23-1 giving a first end portion 21 of the coil 20;

FIG. 4 depicts part of the inductor 11 depicted in FIG. 2, and is a sectional view depicting a non-conductive material layer 19-2 provided with a via conductor 24-1 connected to the line conductor 23-1;

FIG. 5 depicts part of the inductor 11 depicted in FIG. 2, and is a plan view depicting the non-conductive material layer 19-2 provided with a line conductor 23-2 connected to the via conductor 24-1;

FIG. 6 depicts part of the inductor 11 depicted in FIG. 2, and is a sectional view depicting a non-conductive material layer 19-3 provided with a via conductor 24-2 connected to the line conductor 23-2;

FIG. 7 depicts part of the inductor 11 depicted in FIG. 2, and is a plan view depicting the non-conductive material layer 19-3 provided with a line conductor 23-3 connected to the via conductor 24-2;

FIG. 8 depicts part of the inductor 11 depicted in FIG. 2, and is a sectional view depicting a non-conductive material layer 19-4 provided with a via conductor 24-3 connected to the line conductor 23-3;

FIG. 9-1 depicts part of the inductor 11 depicted in FIG. 2, and is a plan view depicting the non-conductive material layer 19-4 provided with a line conductor 23-4 connected to the via conductor 24-3;

FIG. 9-2 is a plan view of part of FIG. 9-1 in an enlarged manner;

FIG. 10 depicts part of the inductor 11 depicted in FIG. 2, and is a sectional view depicting a non-conductive material layer 19-5 provided with a via conductor 24-4 connected to the line conductor 23-4;

FIG. 11 depicts part of the inductor 11 depicted in FIG. 2, and is a plan view depicting the non-conductive material layer 19-5 provided with a line conductor 23-5 connected to the via conductor 24-4;

FIG. 12 depicts part of the inductor 11 depicted in FIG. 2, and is a sectional view depicting a non-conductive material layer 19-6 provided with a via conductor 24-5 connected to the line conductor 23-5;

FIG. 13 depicts part of the inductor 11 depicted in FIG. 2, and is a plan view depicting the non-conductive material layer 19-6 provided with a line conductor 23-6 connected to the via conductor 24-5;

FIG. 14 depicts part of the inductor 11 depicted in FIG. 2, and is a sectional view depicting a non-conductive material layer 19-7 provided with a via conductor 24-6 connected to the line conductor 23-6;

FIG. 15 depicts part of the inductor 11 depicted in FIG. 2, and is a plan view depicting the non-conductive material layer 19-7 provided with a line conductor 23-7 connected to the via conductor 24-6;

FIG. 16 depicts part of the inductor 11 depicted in FIG. 2, and is a sectional view depicting a non-conductive material layer 19-8 provided with a via conductor 24-7 connected to the line conductor 23-7;

FIG. 17 depicts part of the inductor 11 depicted in FIG. 2, and is a plan view depicting the non-conductive material layer 19-8 provided with a line conductor 23-8 connected to the via conductor 24-7;

FIG. 18 depicts part of the inductor 11 depicted in FIG. 2, and is a sectional view depicting a non-conductive material layer 19-9 provided with a via conductor 24-8 connected to the line conductor 23-8;

FIG. 19 depicts part of the inductor 11 depicted in FIG. 2, and is a plan view depicting the non-conductive material layer 19-9 provided with a line conductor 23-9 connected to the via conductor 24-8;

FIG. 20 depicts part of the inductor 11 depicted in FIG. 2, and is a sectional view depicting a non-conductive material layer 19-10 provided with a via conductor 24-9 connected to the line conductor 23-9;

FIG. 21 depicts part of the inductor 11 depicted in FIG. 2, and is a plan view depicting the non-conductive material layer 19-10 provided with a line conductor 23-10 connected to the via conductor 24-9;

FIG. 22 depicts part of the inductor 11 depicted in FIG. 2, and is a sectional view depicting a non-conductive material layer 19-11 provided with a via conductor 24-10 connected to the line conductor 23-10;

FIG. 23 depicts part of the inductor 11 depicted in FIG. 2, and is a plan view depicting the non-conductive material layer 19-11 provided with a line conductor 23-11 connected to the via conductor 24-10;

FIG. 24 depicts part of the inductor 11 depicted in FIG. 2, and is a sectional view depicting a non-conductive material layer 19-12 provided with a via conductor 24-11 connected to the line conductor 23-11;

FIG. 25 depicts part of the inductor 11 depicted in FIG. 2, and is a plan view depicting the non-conductive material layer 19-12 provided with a line conductor 23-12 connected to the via conductor 24-11 and giving a second end portion 22 of the coil 20;

FIG. 26 is another view of the inductor 11 depicted in FIG. 1 seen through to the axial direction of the coil 20;

FIG. 27 is still another view of the inductor 11 depicted in FIG. 1 seen through to the axial direction of the coil 20;

FIG. 28 depicts an inductor 11A according to a second embodiment of the present disclosure, and corresponds to FIG. 2;

FIG. 29 depicts an inductor 11B according to a third embodiment of the present disclosure, and corresponds to FIG. 2;

FIG. 30 depicts an inductor 11C according to the third embodiment of the present disclosure, and corresponds to FIG. 2;

FIG. 31 is a see-through perspective view of an inductor 11D according to a fourth embodiment of the present disclosure; and

FIG. 32 depicts the inductor 11D depicted in FIG. 31 seen through to an axial direction of a coil 20D, and corresponds to FIG. 2.

### DETAILED DESCRIPTION

An inductor of the present disclosure is described below. Note that the present disclosure is not limited to the following structures and can be changed as appropriate in a range not deviating from the gist of the present disclosure. Also, one obtained by combining a plurality of individual preferable structures described below is also an aspect of the present disclosure.

It goes without saying that each embodiment described below is an example and structures described in different embodiments can be partially replaced or combined. Description of matters common to a first embodiment is omitted in a second embodiment onward and different points are mainly described therein. In particular, similar operations and effects by similar structures are not mentioned one by one for each embodiment.

In the description below, the simple term “inductor of the present disclosure” is used when the embodiments are not particularly distinguished from one another.

The drawings described below are schematic views, and the scale of the aspect ratio and so forth may be different from those of actual products.

In the specification, a term indicating a relationship between components (for example, “parallel”, “perpendicular”, “orthogonal”, or the like) and a term indicating the shape of a component each mean not only a literally-strict mode but also a mode in a substantially equivalent range, for example, the range with a difference on the order of several percents.

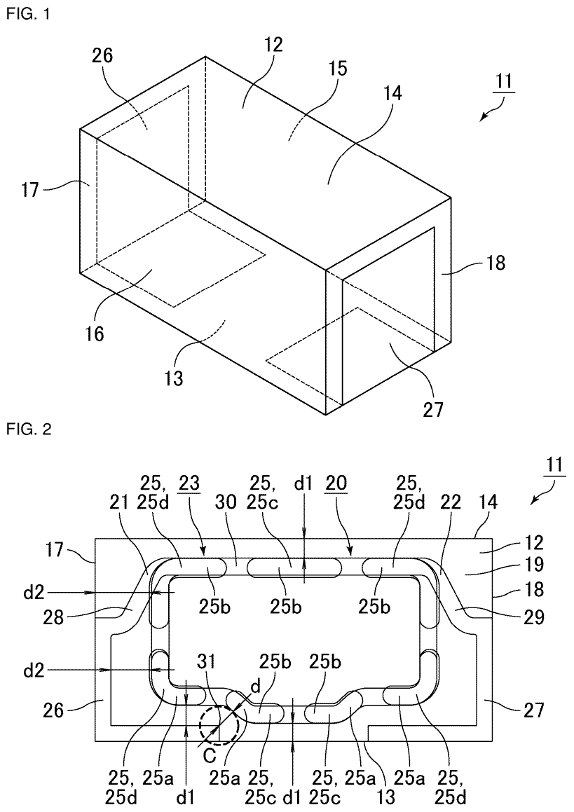

With reference to FIG. 1 to FIG. 11, an inductor 11 according to the first embodiment of the present disclosure is described.

The inductor 11 includes a component main body 12. The component main body 12 is made of, for example, a non-conductive material containing at least one of glass, resin, and ferrite. Also, when the component main body 12 is formed of a body molded from resin or the like, the component main body 12 may contain a non-magnetic filler made of silica or the like or a magnetic filler made of ferrite, a metal magnetic material, or the like. Furthermore, the component main body 12 may have a structure obtained by combining two or more of glass, ferrite, and resin. The component main body 12 has a rectangular-parallelepiped shape. The rectangular-parallelepiped shape may be, for example, a shape with its edge-line portions and corner portions rounded or beveled.

More specifically, as depicted in FIG. 1, the component main body 12 in the rectangular-parallelepiped shape has a mount surface 13 oriented to a mounting-board side, a top surface 14 opposed to the mount surface 13, a first side surface 15 and a second side surface 16 coupling the mount surface 13 and the top surface 14 together and opposed to each other, and a first end surface 17 and a second end surface 18 coupling the mount surface 13 and the top surface 14 and coupling the first side surface 15 and the second side surface 16 together and opposed to each other.

The component main body 12 has a multilayer structure in which a plurality of non-conductive material layers 19 made of any of the non-conductive materials described above are stacked. The plurality of non-conductive material layers 19 are stacked from the first side surface 15 toward the second side surface 16. Principal surfaces of the non-conductive material layers 19 positioned at end portions in a stacking direction give the first side surface 15 and the second side surface 16 of the component main body 12.

Inside the component main body 12, a coil 20 is arranged, as depicted in FIG. 2. The coil 20 extends along a helical path. The axial line of the coil 20 is oriented toward a direction orthogonal to the side surfaces 15 and 16, that is, a direction parallel to the mount surface 13. The coil 20 includes a first end portion 21 and a second end portion 22 that are opposite to each other, and also includes, between the first end portion 21 and the second end portion 22, a plurality of line conductors 23 extending any interface of the plurality of non-conductive material layers 19 and a plurality of via conductors penetrating through any of the non-conductive material layers 19 to a thickness direction. Note that while depiction of the via conductors is omitted in FIG. 2, all of the via conductors in the present embodiment are longitudinal via conductors in a longitudinal shape extending along the line conductors 23. In each of the line conductors 23, its one end portion has a pad portion 25 connected to the via conductor. Also, in the line conductor 23, a portion except its one end portion has a line wire portion 30 connected to the pad portion 25. In the coil 20, with the line conductors 23 and the via conductors described above being alternately connected, a shape extending along the helical path is given as a whole. Each pad portion 25 includes a longitudinal pad portion connected to the longitudinal via conductor. In the present embodiment, all of the depicted pad portions 25 are longitudinal pad portions connected to the longitudinal via conductors. The reference numeral “25” used to indicate a pad portion is also used for each longitudinal pad portion. Note that an interface between the plurality of non-conductive material layers 19 may be unclear due to firing or the like.

In the specification, as depicted in FIG. 2, when seen through to the axial direction of the coil, a direction orthogonal to the direction in which the line conductor extends is set as a width direction of that line conductor and width directions of the pad portion and the line wire portion included in that line conductor. Also, width-direction dimensions of the line conductor, the pad portion, and the line wire portion are set as dimensions of the line conductor, the pad portion, and the line wire portion in the width directions.

In the present embodiment, the width-direction dimension of the line conductor 23 changes between the longitudinal pad portion 25 and the line wire portion 30. The width-direction dimension of the longitudinal pad portion 25 is set larger than the width-direction dimension of the line wire portion 30. Thus, the width-direction dimension of the longitudinal via conductor connected to the longitudinal pad portion 25 can be set large, and connection reliability between the line conductor 23 and the longitudinal via conductor can be ensured.

Note that in the specification, the width-direction dimension of the via conductor is set as a dimension in a direction orthogonal to the direction in which the line conductor connected to that via conductor extends. However, when the via conductor is a longitudinal via conductor, the width-direction dimension of the longitudinal via conductor can also be said as a dimension in a direction orthogonal to a longitudinal direction of that longitudinal via conductor.

In the present embodiment, each longitudinal pad portion 25 is a uniform pad portion having a uniform width-direction dimension. The width-direction dimension of the uniform pad portion is the same, and does not vary depending on the position in the direction in which the relevant line conductor 23 extends. That is, the width-direction dimension of the uniform pad portion does not change in the direction in which the relevant line conductor 23 extends. Note that the relevant line conductor 23 means the line conductor 23 that has the uniform pad portion.

Each line wire portion 30 is a uniform line wire portion having a uniform width-direction dimension. The width-direction dimension of the uniform line wire portion is the same, and does not vary depending on the position in the direction in which the relevant line conductor 23 extends. That is, the width-direction dimension of the uniform line wire portion does not change in the direction in which the relevant line conductor 23 extends. Note that the relevant line conductor 23 means the line conductor 23 that has the line wire portion 30.

Also, as depicted in FIG. 2, when seen through to the axial direction of the coil 20, the arrangement positions of all line wire portions 30 match. In more detail, the center positions of all line wire portions 30 in the width direction are present on the same closed curve and is not shifted from that curve.

On the outer surfaces of the component main body 12, a first outer terminal electrode 26 and a second outer terminal electrode 27 respectively connected to the first end portion 21 and the second end portion 22 of the coil 20 are provided. The first outer terminal electrode 26 and the second outer terminal electrode 27 are provided so as to be exposed from the outer surfaces of the component main body 12, and are each provided over two surfaces, that is, the mount surface 13 of the component main body 12 and the first end surface 17 and the second end surface 18, respectively, adjacent thereto. With the first outer terminal electrode 26 and the second outer terminal electrode 27 provided in the above-described manner, when the inductor 11 is mounted on a mounting board, a solder fillet in an appropriate shape can be formed. Thus, a highly-reliably mount state can be obtained in both of electrical connection and mechanical bonding. The first outer terminal electrode 26 and the second outer terminal electrode 27 are provided so as to penetrate in a thickness direction through each of the plurality of non-conductive material layers 19 except several non-conductive material layers 19 positioned at both end portions in the stacking direction.

Note that the surfaces of the component main body 12 where the first outer terminal electrode 26 and the second outer terminal electrode 27 are provided are not particularly limited, and may be provided, for example, only on the mount surface 13 of the component main body 12 or only on the first end surface 17 and the second end surface 18 of the component main body 12.

The coil 20 and the outer terminal electrodes 26 and 27 described above are each formed by, for example, patterning a conductive film made of conductive paste containing Ag as a conductive component. Also, each non-conductive material layer 19 is formed by, for example, patterning a non-conductive material film made of paste containing a non-conductive material containing at least one of glass, resin, and ferrite, as required. For patterning the conductive film and patterning the non-conductive material film, for example, photolithography, semi-additive process, screen printing, transfer process, or the like is applied.

Although not depicted, on portions of the outer terminal electrodes 26 and 27 exposed from the component main body 12, plating films may be formed. The plating films include, for example, a Ni-plated layer and a Sn-plated layer thereon.

As depicted in FIG. 2, when seen through to the axial direction of the coil 20, the center position of each longitudinal pad portion 25 in the width direction is shifted from the center position of the line wire portion 30 in the width direction to at least one of an inner circumferential side and an outer circumferential side of the helical path. As a result, the longitudinal pad portion 25 is set so as to project from at least one of the inner circumferential edge and the outer circumferential edge of the line wire portion 30.

As described above, it is preferable that the longitudinal via conductor has a long length in its longitudinal direction and the via conductor has a thick thickness in its stacking direction. Thus, when the longitudinal via conductor is shifted to the inner circumferential side of the helical path, influences of blocking the magnetic flux passing through the inside of the coil are large, and there is a possibility of being incapable of suppressing degradation in Q characteristics. By contrast, in the present embodiment, the thickness of the longitudinal pad portion 25 in its stacking direction can be made thinner compared with the via conductor. Therefore, as described above, if the center position of the longitudinal pad portion 25 in the width direction is shifted from the center position of the line wire portion 30 in the width direction to at least one of the inner circumferential side and the outer circumferential side of the helical path, influences of blocking the magnetic flux passing through the inside of the coil 20 are smaller, compared with the case in which the longitudinal via conductor is shifted to the inner circumferential side of the helical path, and degradation in Q characteristics can be suppressed. That is, the Q characteristics can be improved.

In the present embodiment, in view of reliability of connection with the longitudinal via conductor in consideration of a staking shift or the like, the longitudinal pad portion 25 preferably has a structure of protruding to the outer circumferential side or the inner circumferential side with respect to the line wire portion 30 and, in particular, the longitudinal pad portion 25 preferably has a structure of protruding to the outer circumferential side with respect to the line wire portion 30 except at a location between the line conductors 23 opposed to the first outer terminal electrode 26 and the second outer terminal electrode 27 and a location where an surface of the component main body 12 and the line conductor 23 are adjacent to each other. The reason for this is that it has been found as a result of many electric field and structure simulations that internal stress tends to concentrate on a location between line conductors opposed to the outer terminal electrodes and a location where a surface of the component main body and the line conductor are adjacent to each other. While a mechanism of this stress concentration is uncertain, this stress concentration is considered to be caused by the Lorentz force occurring between the line conductors opposed to the outer terminal electrodes and the external stress occurring on the surface of the component main body. Therefore, with the above-described preferable structure, it is possible to obtain high reliability with an increase in internal stress also being suppressed and obtain high Q characteristics with blocking of the magnetic flux passing through the inside of the coil by the longitudinal pad portion 25 being suppressed to minimum.

In more detail, as depicted in FIG. 2, when seen through to the axial direction of the coil 20, of the longitudinal pad portion 25, the center position in the width direction of at least a portion 25a most adjacent to the first outer terminal electrode 26 or the second outer terminal electrode 27 is preferably shifted from the center position of the line wire portion 30 in the width direction to the inner circumferential side of the helical path.

Note that in the specification, the portion most adjacent to the first outer terminal electrode or the second outer terminal electrode means a portion of portions adjacent to the first outer terminal electrode or the second outer terminal electrode, the portion in which a space between the outer circumferential edge of that portion and an inner end surface of the first outer terminal electrode or the second outer terminal electrode is within a range of s1+3% (including boundary values), where s1 is a minimum value of that space.

Note that in the specification, the “inner end surface of the outer terminal electrode” means a surface opposed to the coil, among surfaces of the outer terminal electrode opposite to a surface exposed to an outer surface of the inductor.

Also, as depicted in FIG. 2, when seen through to the axial direction of the coil 20, of the longitudinal pad portion 25, the center position in the width direction of at least a portion 25b most adjacent to the surface of the component main body 12 is preferably shifted from the center position of the line wire portion 30 in the width direction to the inner circumferential side of the helical path.

Note that in the specification, the portion most adjacent to the surface of the component main body means a portion of portions adjacent to the surface of the component main body, the portion in which a space between the outer circumferential edge of that portion and the surface of the component main body is within a range of s2+3% (including boundary values), where s2 is a minimum value of that space. Also, the surface of the component main body to which the relevant portion is most adjacent is preferably the top surface of the component main body.

Also, when all longitudinal pad portions 25 commonly protrude to the inner circumferential side of the helical path, all longitudinal pad portions 25 block the magnetic flux passing through the inside of the coil 20, and thus it is difficult to obtain an effect of improving Q characteristics. On the other hand, when all longitudinal pad portions 25 commonly protrude to the outer circumferential side of the helical path, the effect of improving Q characteristics is high but, as described above, a high-stress location (specifically, a location on the periphery of the first outer terminal electrode 26 and the second outer terminal electrode 27) may occur inside the component main body 12, the high-stress location inside the component main body 12 may become close to a surface (for example, the top surface 14) of the component main body 12 and, as a result, there is a possibility that a fracture, a chip, a crack, or the like may occur in the component main body 12.

Thus, in the present embodiment, as depicted in FIG. 2, when seen through to the axial direction of the coil 20, the longitudinal pad portions 25 include a plurality of longitudinal pad portions 25 with their directions shifted from the center position of the line wire portion 30 in the width direction varying from one another. This can adjust the direction and the position in and at which the longitudinal pad portion 25 protrudes from the line wire portion 30. Thus, while blocking the magnetic flux passing through the inside of the coil 20 by the longitudinal pad portion 25 is suppressed to minimum to improve Q characteristics, the occurrence of a fracture, a chip, and a crack in the component main body 12 due to an increase in internal stress can be suppressed.

More specifically, there are provided a plurality of longitudinal pad portions 25c in which the center position in the width direction is shifted from the center position of the line wire portion 30 in the width direction only to the inner circumferential side of the helical path and longitudinal pad portions 25d in which the center position in the width direction is shifted from the center position of the line wire portion 30 in the width direction to both of the inner circumferential side and the outer circumferential side of the helical path.

Note that the longitudinal pad portions 25 may include a longitudinal pad portion in which the center position in the width direction is shifted from the center position of the line wire portion 30 in the width direction only to the outer circumferential side of the helical path.

Also, as depicted in FIG. 2, when seen through to the axial direction of the coil 20, each longitudinal pad portion 25d is also a longitudinal pad portion in which the direction shifted from the center position of the line wire portion 30 in the width direction varies depending on the position in a direction in which the relevant line conductor 23 extends. Also with this, it is possible to adjust the direction and the position in and at which the longitudinal pad portion 25 protrudes from the line wire portion 30. Thus, while internal blocking of the coil 20 by the longitudinal pad portion 25 is minimized to improve Q characteristics, the occurrence of a fracture, a chip, and a crack in the component main body 12 due to an increase in stress can be suppressed.

More specifically, in the longitudinal pad portion 25d, the direction shifted from the center position of the line wire portion 30 in the width direction changes from the inner circumferential side to the outer circumferential side of the helical path in the direction in which the relevant line conductor 23 extends. Note that the relevant line conductor 23 means the line conductor 23 having this longitudinal pad portion 25d,

Also, as depicted in FIG. 2, when a shortest distance between a corner portion 31 oriented to a line wire portion 30 side of the first outer terminal electrode 26 or the second outer terminal electrode 27 and the outer circumferential edge of the line wire portion 30 is taken as d when seen through to the axial direction of the coil 20, the line wire portion 30 has a first area in which a space d1 from an inner end surface of the first outer terminal electrode 26 or the second outer terminal electrode 27 or the surface of the component main body 12 is smaller than or equal to d and a second area in which a space d2 from the inner end surface of the first outer terminal electrode 26 or the second outer terminal electrode 27 or the surface of the component main body 12 is larger than d. And, as depicted in FIG. 2, of the longitudinal pad portion 25, the center position in the width direction of a portion overlapping the first area (area with the space d1) is shifted from the center position of the first area in the width direction to the inner circumferential side of the helical path when seen through to the axial direction of the coil 20, and, of the longitudinal pad portion 25, the center position in the width direction of a portion overlapping the second area (area with the space d2) is shifted from the center position of the second area in the width direction to the outer circumferential side of the helical path when seen through to the axial direction of the coil 20. With this, while internal stress concentrating between the line conductors 23 opposed to the first outer terminal electrode 26 and the second outer terminal electrode 27 is more reliably prevented from being increased and internal stress at a location where the surface of the component main body 12, which is vulnerable to external impact, and the line conductor 23 are adjacent to each other is more reliably prevented from being increased, it is possible to obtain high Q characteristics with blocking of the magnetic flux passing through the inside of the coil by the longitudinal pad portion 25 being suppressed to minimum.

Note that the shortest distance d means a shortest one of shortest distances each between a corner portion oriented to a line wire portion 30 side of each of the first outer terminal electrode 26 and the second outer terminal electrode 27 and the outer circumferential edge of the line wire portion 30 when seen through to the axial direction of the coil 20. In the present embodiment, normally, as depicted in FIG. 2, a distance between the corner portion 31 on the mount surface 13 side of the plurality of corner portions and the outer circumferential edge of the line wire portion 30 is the shortest.

Also, a space between the first area or the second area and the inner end surface of the first outer terminal electrode 26 or the second outer terminal electrode 27 or the surface of the component main body 12 means a space between the outer circumferential edge of the first area or the second area and the inner end surface of the first outer terminal electrode 26 or the second outer terminal electrode 27 or the surface of the component main body 12.

Also, when the distance d1 between the first area and the inner end surface of the first outer terminal electrode 26 or the second outer terminal electrode 27 or the surface of the component main body 12 is equal to d, this means a case in which that space is within a range of d±3% (including boundary values).

Also, when the space d1 or d2 between the first area or the second area and the inner end surface of the first outer terminal electrode 26 or the second outer terminal electrode 27 or the surface of the component main body 12 is smaller or larger than d, this means a case in which that space is below or exceeds the range of d±3%.

Note that in the inductor of the present disclosure, various dimensions and distances can be measured by, for example, a method described below. That is, a see-through image of the inductor viewed from the axial direction of the coil is taken by a CT system for X-ray fluoroscopy and measurement and that see-through image is subjected to image processing, thereby measuring various dimensions and distances. As a CT system for X-ray fluoroscopy and measurement, for example, one manufactured by Comet Technologies can be used. Also, as the above-described shortest distance d, for example, in the example depicted in FIG. 2, it is possible to set the radius of a circle C that takes the corner portion 31 of the first outer terminal electrode 26 or the second outer terminal electrode 27 as a center and approximates to an arc-shaped portion of the outer circumferential edge of the line wire portion 30.

While the shortest distance d is not particularly limited, but is preferably 10 μm or more. This can suppress a short circuit between the first outer terminal electrode 26 and the second outer terminal electrode 27 and the line wire portion 30.

As described above, the longitudinal pad portion 25 has a first portion (portion protruding to the inner circumferential side of the helical path) in which the center position in the width direction is shifted from the center position of the line wire portion 30 in the width direction to the inner circumferential side of the helical path and a second portion (portion protruding to the outer circumferential side of the helical path) in which the center position in the width direction is shifted from the center position of the line wire portion 30 in the width direction to the outer circumferential side of the helical path. And, when seen through to the axial direction of the coil 20, a space between an area of the line wire portion 30 overlapping this first portion and the inner end surface of the first outer terminal electrode 26 or the second outer terminal electrode 27 or the surface of the component main body 12 is smaller than a space between an area of the line wire portion 30 overlapping this second portion and the inner end surface of the first outer terminal electrode 26 or the second outer terminal electrode 27 or the surface of the component main body 12. Also with this, it is possible to obtain high reliability with an increase in internal stress being suppressed and obtain high Q characteristics with blocking of the magnetic flux passing through the inside of the coil by the longitudinal pad portion 25 being suppressed to minimum.

Note that the space between the area overlapping the first portion or the second portion and the inner end surface of the first outer terminal electrode 26 or the second outer terminal electrode 27 or the surface of the component main body 12 means a space between the outer circumferential edge of the area overlapping the first portion or the second portion and the inner end surface of the first outer terminal electrode 26 or the second outer terminal electrode 27 or the surface of the component main body 12.

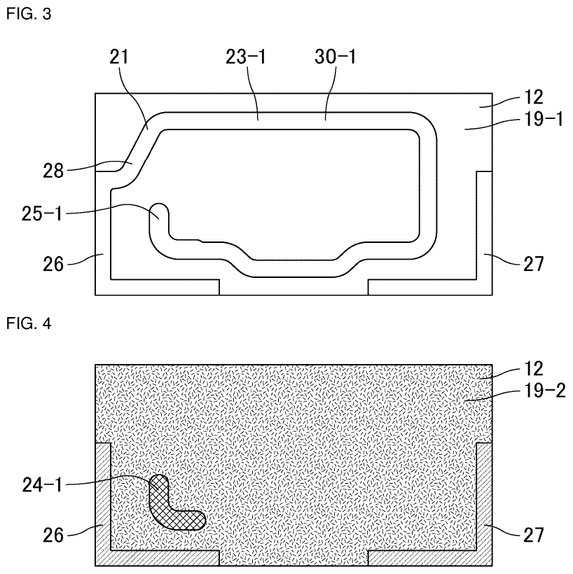

With reference mainly to FIG. 3 to FIG. 11, linkages of the plurality of line conductors 23 in the coil 20 are more specifically described.

The line conductors 23 depicted in FIG. 2 include twelve line conductors 23 connected via eleven via conductors. The via conductors include a longitudinal via conductor in a longitudinal shape extending along the line conductor 23. In the present embodiment, all of the depicted via conductors are longitudinal via conductors. The reference numeral “24” used to indicate a via conductor is also used for each longitudinal via conductors. Note that in the inductor of the present disclosure, the via conductors may include a via conductor other than the longitudinal via conductors and may also include a pad portion connected to the via conductor other than the longitudinal via conductors. Here, the via conductor other than the longitudinal via conductors means a general via conductor having a shape not extending along the line conductor. The pad portions may include a pad portion other than the longitudinal pad portions. The pad portion other than the longitudinal pad portions means a general pad portion having a shape not extending along the line conductor.

Also, in FIG. 3 to FIG. 11, for the purpose of distinguishing the eleven via conductors from one another, the eleven via conductors are each provided with reference numerals “24-1”, “24-2”, “24-3”, “24-4”, “24-5”, “24-6”, “24-7”, “24-8”, “24-9”, “24-10”, and “24-11”.

Also, for the purpose of distinguishing the line conductors 23 depicted in FIG. 2, the twelve line conductors 23 are each provided with reference numerals “23-1”, “23-2”, “23-3”, “23-4”, “23-5”, “23-6”, “23-7”, “23-8”, “23-9”, “23-10”, “23-11”, and “23-12”. The line conductors 23-1, 23-2, 23-3, 23-4, 23-5, 23-6, 23-7, 23-8, 23-9, 23-10, 23-11, and 23-12 each extend along a different interface between the non-conductive material layers 19.

Also the pad portions 25 given by one end portions of the line conductors 23-1, 23-2, 23-3, 23-4, 23-5, 23-6, 23-7, 23-8, 23-9, 23-10, and 23-11 are each provided with reference numerals “25-1”, “25-2”, “25-3”, “25-4”, “25-5”, “25-6”, “25-7”, “25-8”, “25-9”, “25-10”, and “25-11”.

Also, the line wire portions 30 given by portions of the line conductors 23-1, 23-2, 23-3, 23-4, 23-5, 23-6, 23-7, 23-8, 23-9, 23-10, 23-11, and 23-12 except their one end portions are each provided with reference numerals “30-1”, “30-2”, “30-3”, “30-4”, “30-5”, “30-6”, “30-7”, “30-8”, “30-9”, “30-10”, “30-11”, and “30-12”.

Also, the non-conductive material layers 19 having the line conductors 23-1, 23-2, 23-3, 23-4, 23-5, 23-6, 23-7, 23-8, 23-9, 23-10, 23-11, and 23-12 provided on their principal surfaces are each provided with reference numerals “19-1”, “19-2”, “19-3”, “19-4”, “19-5”, “19-6”, “19-7”, “19-8”, “19-9”, “19-10”, “19-11”, and “19-12”. The non-conductive material layers 19-1, 19-2, 19-3, 19-4, 19-5, 19-6, 19-7, 19-8, 19-9, 19-10, 19-11, and 19-12 are stacked in this sequence from below to above.

To the first end portion 21 and the second end portion 22 of the coil 20, a first extended conductor 28 and a second extended conductor 29 are respectively connected. These first extended conductor 28 and second extended conductor 29 are given by extended portions of the line conductors 23-1 and 23-12 that respectively position the first end portion 21 and the second end portion 22 of the coil 20.

Note that in the specification, “line conductor”, “extended conductor”, and “outer terminal electrode” are defined and distinguished from one another as follows. The “line conductor” refers to a portion wound in a state of being seen through to the axial direction of the coil. The “extended conductor” refers to a portion extending out of the above-described winding portion. The “outer terminal electrode” refers to a portion exposed from the component main body.

First, as depicted in FIG. 3, on the non-conductive material layer 19-1, the line conductor 23-1 connected to the first outer terminal electrode 26 via the first extended conductor 28 extends to a clockwise direction via the line wire portion 30-1 to the longitudinal pad portion 25-1.

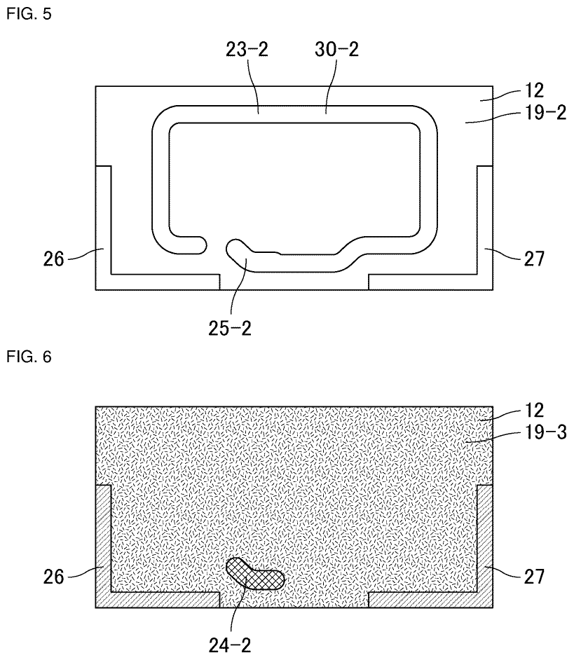

Next, the non-conductive material layer 19-2 depicted in FIG. 4 is stacked on the non-conductive material layer 19-1. The longitudinal via conductor 24-1 is provided so as to penetrate through the non-conductive material layer 19-2. The longitudinal via conductor 24-1 connects the line conductor 23-1 and the line conductor 23-2 depicted in FIG. 5 together via the longitudinal pad portion 25-1.

Next, as depicted in FIG. 5, on the non-conductive material layer 19-2, the line conductor 23-2 extends to a clockwise direction from the position of the longitudinal via conductor 24-1 via the line wire portion 30-2 to the longitudinal pad portion 25-2.

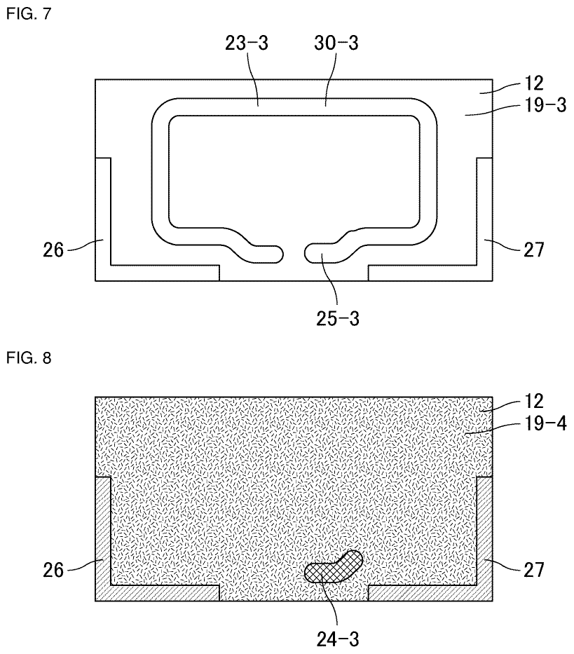

Next, the non-conductive material layer 19-3 depicted in FIG. 6 is stacked on the non-conductive material layer 19-2. The longitudinal via conductor 24-2 is provided so as to penetrate through the non-conductive material layer 19-3. The longitudinal via conductor 24-2 connects the line conductor 23-2 and the line conductor 23-3 depicted in FIG. 7 together via the longitudinal pad portion 25-2.

Next, as depicted in FIG. 7, on the non-conductive material layer 19-3, the line conductor 23-3 extends to a clockwise direction from the position of the longitudinal via conductor 24-2 via the line wire portion 30-3 to the longitudinal pad portion 25-3.

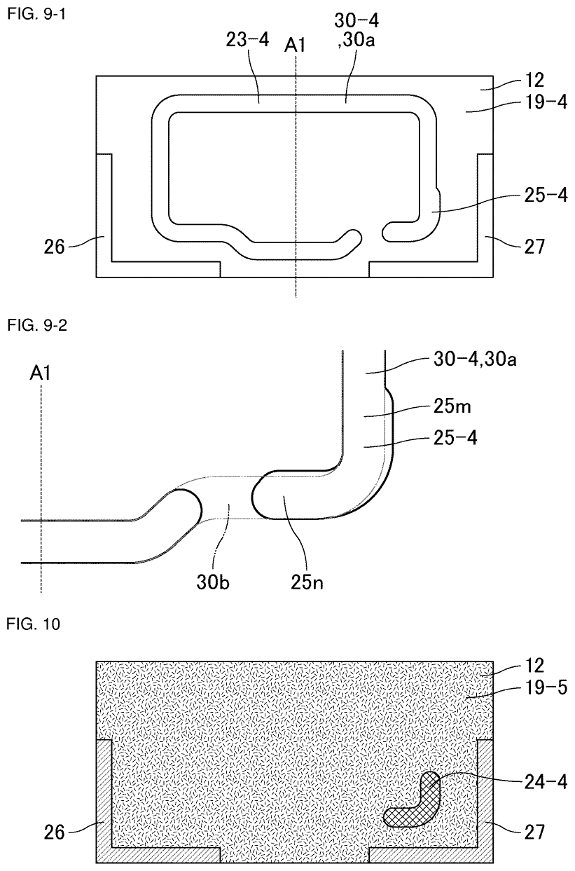

Next, the non-conductive material layer 19-4 depicted in FIG. 8 is stacked on the non-conductive material layer 19-3. The longitudinal via conductor 24-3 is provided so as to penetrate through the non-conductive material layer 19-4. The longitudinal via conductor 24-3 connects the line conductor 23-3 and the line conductor 23-4 depicted in FIG. 9-1 together via the longitudinal pad portion 25-3.

Next, as depicted in FIG. 9-1, on the non-conductive material layer 19-4, the line conductor 23-4 extends to a clockwise direction from the position of the longitudinal via conductor 24-3 via the line wire portion 30-4 to the longitudinal pad portion 25-4.

Here, with reference to FIG. 9-1 and FIG. 9-2, features of the line conductor 23-4 are further described.

The line wire portion 30-4 of the line conductor 23-4 is a line-symmetric line wire portion 30a having a line-symmetric shape. As depicted in FIG. 9-1, the line-symmetric line wire portion 30a has a line-symmetric shape with respect to a symmetry axis A1.

The longitudinal pad portion 25-4 is connected to the line-symmetric line wire portion 30a, and includes a third portion 25m and a fourth portion 25n sequentially arranged to a direction in which the relevant line conductor 23-4 extends, as depicted in FIG. 9-2.

Also, as depicted in FIG. 9-2, a portion obtained by folding the line-symmetric line wire portion 30a along its symmetry axis A1 to the third portion 25m and the fourth portion 25n is set as a virtual line wire portion 30b. Note that virtual line wire portion 30b is indicated by a two-dot-chain line in FIG. 9-2.

And, as depicted in FIG. 9-2, the inner circumferential edge of the third portion 25m of the longitudinal pad portion 25-4 is positioned on the inner circumferential edge of the virtual line wire portion 30b, the outer circumferential edge of the third portion 25m of the longitudinal pad portion 25-4 protrudes from the outer circumferential edge of the virtual line wire portion 30b, the inner circumferential edge of the fourth portion 25n of the longitudinal pad portion 25-4 protrudes from the inner circumferential edge of the virtual line wire portion 30b, and the outer circumferential edge of the fourth portion 25n of the longitudinal pad portion 25-4 is positioned on the outer circumferential edge of the virtual line wire portion 30b. With this, it is possible to adjust the direction and the position in and at which the longitudinal pad portion 25-4 protrudes from the line wire portion 30-4. Thus, while internal blocking of the coil 20 by the longitudinal pad portion 25-4 is minimized to improve Q characteristics, the occurrence of a fracture, a chip, and a crack in the component main body 12 due to an increase in stress can be suppressed.

Also, as depicted in FIG. 9-2, the longitudinal pad portion 25-4 may be bent between the third portion 25m and the fourth portion 25n.

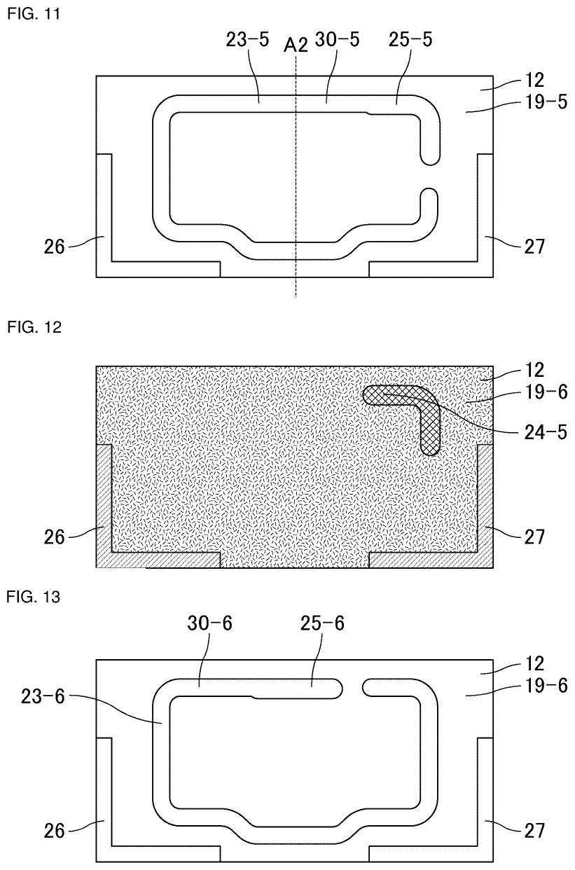

Next, the non-conductive material layer 19-5 depicted in FIG. 10 is stacked on the non-conductive material layer 19-4. The longitudinal via conductor 24-4 is provided so as to penetrate through the non-conductive material layer 19-5. The longitudinal via conductor 24-4 connects the line conductor 23-4 and the line conductor 23-5 depicted in FIG. 11 together via the longitudinal pad portion 25-4.

Next, as depicted in FIG. 11, on the non-conductive material layer 19-5, the line conductor 23-5 extends to a clockwise direction from the position of the longitudinal via conductor 24-4 via the line wire portion 30-5 to the longitudinal pad portion 25-5.

Note that the line wire portion 30-5 is a line-symmetric line wire portion having a line-symmetric shape with respect to a symmetry axis A2 and, as with the longitudinal pad portion 25-4, the longitudinal pad portion 25-5 includes a third portion protruding to an outer circumferential side of a virtual line wire portion and a fourth portion protruding to an inner circumferential side of the virtual line wire portion.

Next, the non-conductive material layer 19-6 depicted in FIG. 12 is stacked on the non-conductive material layer 19-5. The longitudinal via conductor 24-5 is provided so as to penetrate through the non-conductive material layer 19-6. The longitudinal via conductor 24-5 connects the line conductor 23-5 and the line conductor 23-6 depicted in FIG. 13 together via the longitudinal pad portion 25-5.

Next, as depicted in FIG. 13, on the non-conductive material layer 19-6, the line conductor 23-6 extends to a clockwise direction from the position of the longitudinal via conductor 24-5 via the line wire portion 30-6 to the longitudinal pad portion 25-6.

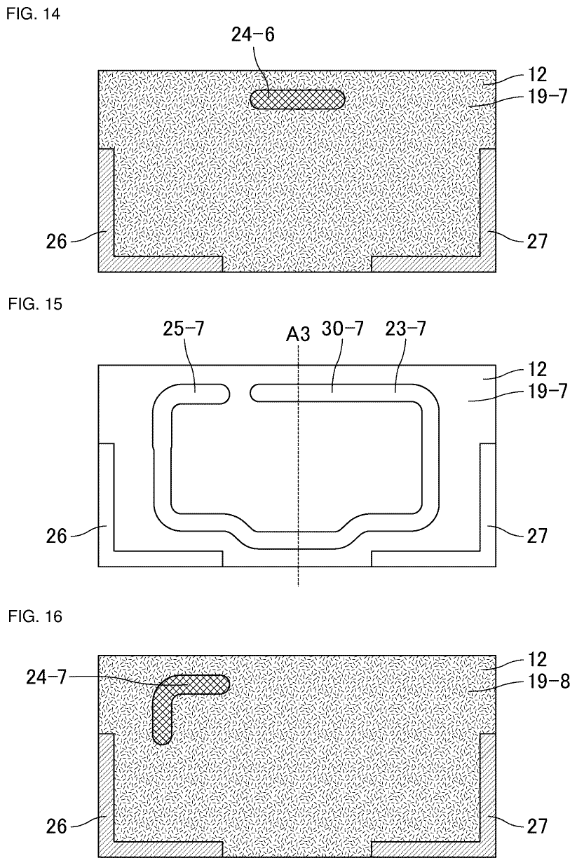

Next, the non-conductive material layer 19-7 depicted in FIG. 14 is stacked on the non-conductive material layer 19-6. The longitudinal via conductor 24-6 is provided so as to penetrate through the non-conductive material layer 19-7. The longitudinal via conductor 24-6 connects the line conductor 23-6 and the line conductor 23-7 depicted in FIG. 15 together via the longitudinal pad portion 25-6.

Next, as depicted in FIG. 15, on the non-conductive material layer 19-7, the line conductor 23-7 extends to a clockwise direction from the position of the longitudinal via conductor 24-6 via the line wire portion 30-7 to the longitudinal pad portion 25-7.

Note that the line wire portion 30-7 is a line-symmetric line wire portion having a line-symmetric shape with respect to a symmetry axis A3 and, as with the longitudinal pad portion 25-4, the longitudinal pad portion 25-7 includes a third portion protruding to an outer circumferential side of a virtual line wire portion and a fourth portion protruding to an inner circumferential side of the virtual line wire portion.

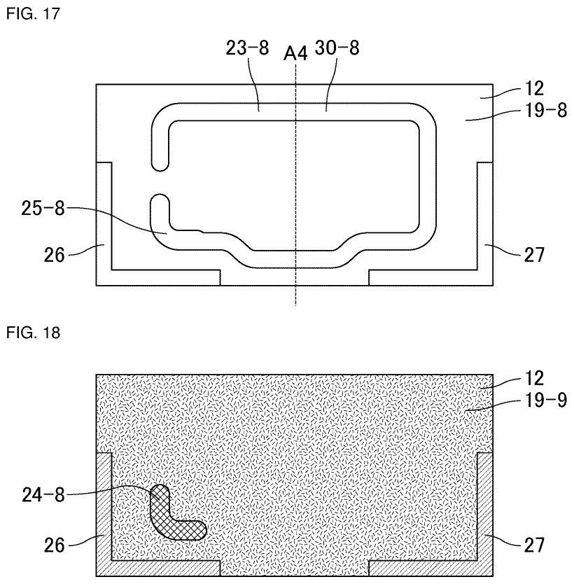

Next, the non-conductive material layer 19-8 depicted in FIG. 16 is stacked on the non-conductive material layer 19-7. The longitudinal via conductor 24-7 is provided so as to penetrate through the non-conductive material layer 19-8. The longitudinal via conductor 24-7 connects the line conductor 23-7 and the line conductor 23-8 depicted in FIG. 17 together via the longitudinal pad portion 25-7.

Next, as depicted in FIG. 17, on the non-conductive material layer 19-8, the line conductor 23-8 extends to a clockwise direction from the position of the longitudinal via conductor 24-7 via the line wire portion 30-8 to the longitudinal pad portion 25-8.

Note that the line wire portion 30-8 is a line-symmetric line wire portion having a line-symmetric shape with respect to a symmetry axis A4 and, as with the longitudinal pad portion 25-4, the longitudinal pad portion 25-8 includes a third portion protruding to an outer circumferential side of a virtual line wire portion and a fourth portion protruding to an inner circumferential side of the virtual line wire portion.

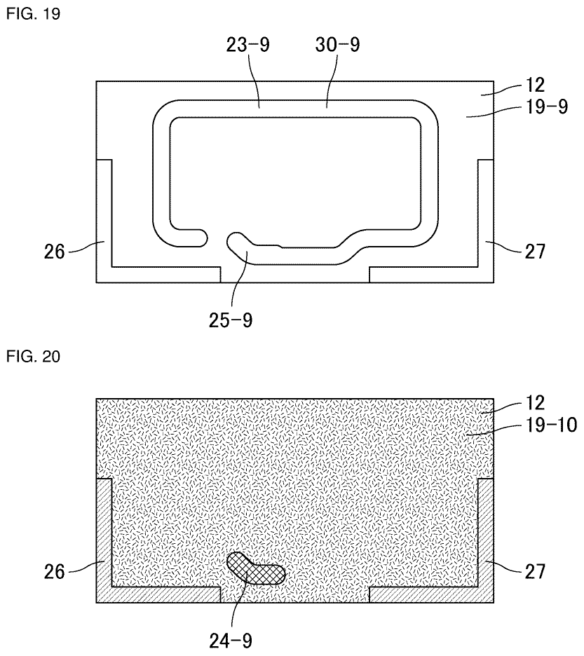

Next, the non-conductive material layer 19-9 depicted in FIG. 18 is stacked on the non-conductive material layer 19-8. The longitudinal via conductor 24-8 is provided so as to penetrate through the non-conductive material layer 19-9. The longitudinal via conductor 24-8 connects the line conductor 23-8 and the line conductor 23-9 depicted in FIG. 19 together via the longitudinal pad portion 25-8.

Next, as depicted in FIG. 19, on the non-conductive material layer 19-9, the line conductor 23-9 extends to a clockwise direction from the position of the longitudinal via conductor 24-8 via the line wire portion 30-9 to the longitudinal pad portion 25-9.

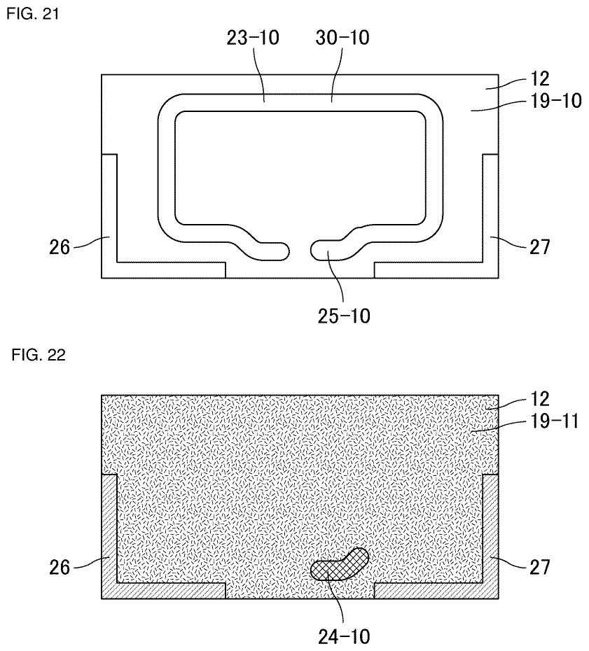

Next, the non-conductive material layer 19-10 depicted in FIG. 20 is stacked on the non-conductive material layer 19-9. The longitudinal via conductor 24-9 is provided so as to penetrate through the non-conductive material layer 19-10. The longitudinal via conductor 24-9 connects the line conductor 23-9 and the line conductor 23-10 depicted in FIG. 21 together via the longitudinal pad portion 25-9.

Next, as depicted in FIG. 21, on the non-conductive material layer 19-10, the line conductor 23-10 extends to a clockwise direction from the position of the longitudinal via conductor 24-9 via the line wire portion 30-10 to the longitudinal pad portion 25-10.

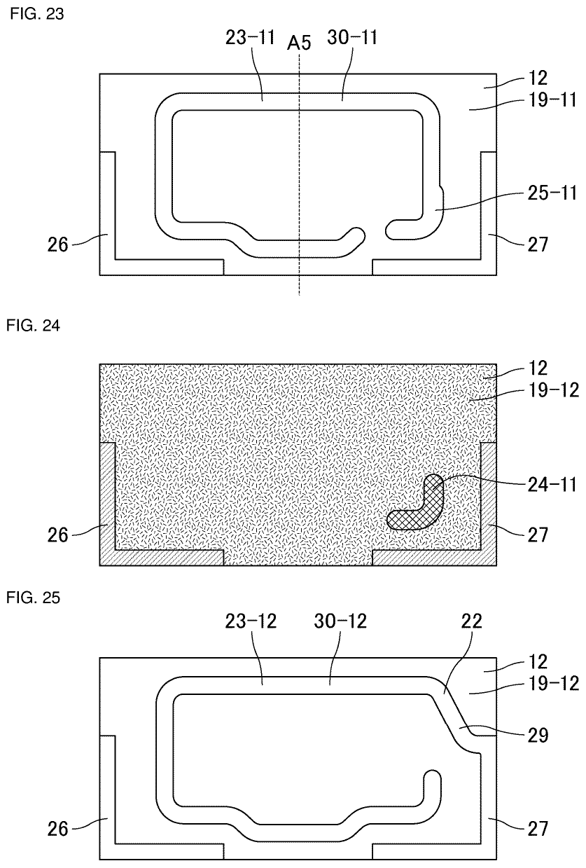

Next, the non-conductive material layer 19-11 depicted in FIG. 22 is stacked on the non-conductive material layer 19-10. The longitudinal via conductor 24-10 is provided so as to penetrate through the non-conductive material layer 19-11. The longitudinal via conductor 24-10 connects the line conductor 23-10 and the line conductor 23-11 depicted in FIG. 23 together via the longitudinal pad portion 25-10.

Next, as depicted in FIG. 23, on the non-conductive material layer 19-11, the line conductor 23-11 extends to a clockwise direction from the position of the longitudinal via conductor 24-10 via the line wire portion 30-11 to the longitudinal pad portion 25-11.

Note that the line wire portion 30-11 is a line-symmetric line wire portion having a line-symmetric shape with respect to a symmetry axis A5 and, as with the longitudinal pad portion 25-4, the longitudinal pad portion 25-11 includes a third portion protruding to an outer circumferential side of a virtual line wire portion and a fourth portion protruding to an inner circumferential side of the virtual line wire portion.

Next, the non-conductive material layer 19-12 depicted in FIG. 24 is stacked on the non-conductive material layer 19-11. The longitudinal via conductor 24-11 is provided so as to penetrate through the non-conductive material layer 19-12. The longitudinal via conductor 24-11 connects the line conductor 23-11 and the line conductor 23-12 depicted in FIG. 25 together via the longitudinal pad portion 25-11.

Next, as depicted in FIG. 25, on the non-conductive material layer 19-12, the line conductor 23-12 extends to a clockwise direction from the position of the longitudinal via conductor 24-11 via the line wire portion 30-12 and is connected via the second extended conductor 29 to the second outer terminal electrode 27.

While the longitudinal pad portion 25 is provided at only one end portion of each line conductor 23 in the present embodiment, each line conductor 23 except the line conductors 23-1 and 23-12 respectively connected to the extended conductors 28 and 29 may be provided with the longitudinal pad portion 25 at each of both ends. For example, in the line conductor 23-2 depicted in FIG. 5, a longitudinal pad portion having the same shape as that of the longitudinal pad portion 25-1 of the line conductor 23-1 depicted in FIG. 3 may be provided at one end portion opposite to the end portion having the longitudinal pad portion 25-2.

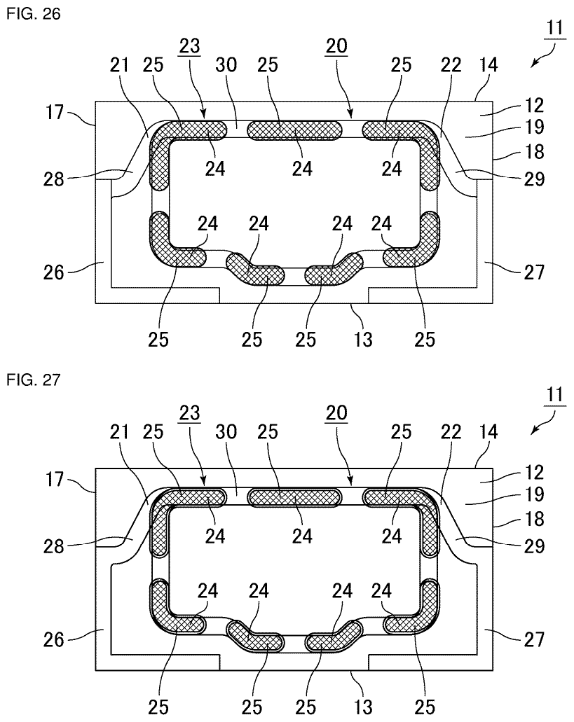

With reference mainly to FIG. 26 and FIG. 27, the structure of the plurality of longitudinal via conductors 24 in the coil 20 is more specifically described.

As depicted in FIG. 26, the width-direction dimension of each longitudinal via conductor 24 may be larger than the width-direction dimension of the line wire portion 30. In this case, high reliability and high Q characteristics described above can be achieved, while reliability of connection between the line conductors 23 is enhanced.

As depicted in FIG. 27, the width-direction dimension of each longitudinal via conductor 24 may be smaller than the width-direction dimension of the line wire portion 30. When seen through to the axial direction of the coil 20, the longitudinal via conductor 24 does not have to protrude from the helical path. In this case, a high-stress location can be further evacuated from a stress-concentrated location and a location to which external impact is directly applied, and the electrode volume of the longitudinal via conductor 24 can be reduced. Thus, higher reliability and higher Q characteristics can be achieved.

Note that in the inductor of the present disclosure, the via conductors may include a via conductor having the same width-direction dimension as that of the line wire portion and the center position of that via conductor in the width direction does not have to be shifted from the center position of the line wire portion in the width direction to both of the inner circumferential side and the outer circumferential side of the helical path, when seen through to the axial direction of the coil. Also, the pad portions may include a pad portion having the same width-direction dimension as that of the line wire portion, and the center position of that pad portion in the width direction does not have to be shifted from the center position of the line wire portion in the width direction to both of the inner circumferential side and the outer circumferential side of the helical path, when seen through to the axial direction of the coil.

In both cases, generally, the width-direction dimension of the via conductor 24 is equal to the width-direction dimension of the pad portion 25 or smaller than the width-direction dimension of the pad portion 25.

As described above, according to the first embodiment, when seen through to the axial direction of the coil 20, the center position of the longitudinal pad portion 25 in the width direction is shifted from the center position of the line wire portion 30 in the width direction to at least one of the inner circumferential side and the outer circumferential side of the helical path. Thus, influences of blocking the magnetic flux passing through the inside of the coil 20 are small, and degradation in Q characteristics can be suppressed. That is, the Q characteristics can be improved.

The above-described effects obtained in the first embodiment are exerted also in the second embodiment onward described below.

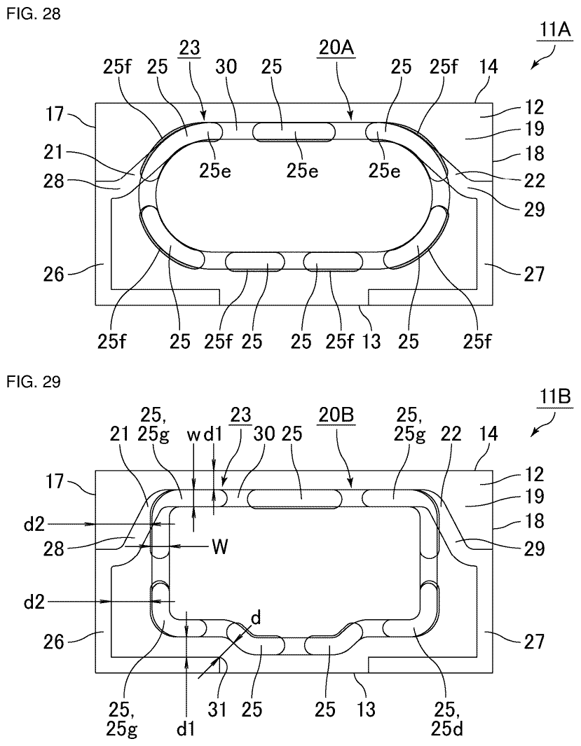

Next, with reference to FIG. 28, an inductor 11A according to the second embodiment of the present disclosure is described. FIG. 28 corresponds to FIG. 2. In FIG. 28, components corresponding to those depicted in FIG. 2 are provided with the same reference characters and redundant description is omitted.

As with the inductor 11 depicted in FIG. 2, the inductor 11A depicted in FIG. 28 has the component main body 12 having a rectangular-parallelepiped shape. However, the shape of a coil 20A of the inductor 11A depicted in FIG. 28 is different from the shape of the coil 20 of the inductor 11 depicted in FIG. 2 and so forth. This indicates that the coil can take any of various shapes. In the first embodiment, when seen through to the axial direction of the coil 20, the coil 20 has a rectangular shape with four corner portions rounded and with a center portion on a long side on a mount surface 13 side protruding to an outer circumferential side. By contrast, in the present embodiment, the coil 20A has two curved portions respectively opposed to the first end surface 17 and the second end surface 18 of the component main body 12 and a linear portion opposed to the top surface 14 of the component main body 12. In this manner, the coil 20A has curved portions to a major-axis direction (longitudinal direction) of the component main body 12. More specifically, the coil 20A has an oval shape when seen through to the axial direction of the coil 20.

As with the inductor 11 depicted in FIG. 2, in the inductor 11A depicted in FIG. 28, when seen through to the axial direction of the coil 20A, the center position of the longitudinal pad portion 25 in the width direction is shifted from the center position of the line wire portion 30 in the width direction to at least one of the inner circumferential side and the outer circumferential side of the helical path. Therefore, as with the first embodiment, influences of blocking the magnetic flux passing through the inside of the coil 20A are made small, and thus degradation in Q characteristics can be suppressed. That is, the Q characteristics can be improved.

In the present embodiment, as depicted in FIG. 28, of the longitudinal pad portions 25, the center position in the width direction of at least parts 25e opposed to the top surface 14 of the component main body 12 in parallel is shifted from the center position of the line wire portion 30 in the width direction to the inner circumferential side of the helical path, and, of the longitudinal pad portions 25, the center position in the width direction of at least parts 25f not opposed to the top surface 14 in parallel is shifted from the center position of the line wire portion 30 in the width direction to the outer circumferential side of the helical path. With this, it is possible to suppress an increase in internal stress at a location where the top surface 14 of the component main body 12, which is vulnerable to external impact, and the line conductor 23 are adjacent to each other. Also, internal stress concentrating between line conductors 23 opposed to the first outer terminal electrode 26 and the second outer terminal electrode 27 can be prevented from being increased, and it is possible to obtain high Q characteristics with blocking of the magnetic flux passing through the inside of the coil by the longitudinal pad portion 25 being suppressed to minimum. Therefore, it is possible to obtain high reliability with an increase in internal stress being suppressed and obtain high Q characteristics with blocking of the magnetic flux passing through the inside of the coil by the longitudinal pad portion 25 being suppressed to minimum.

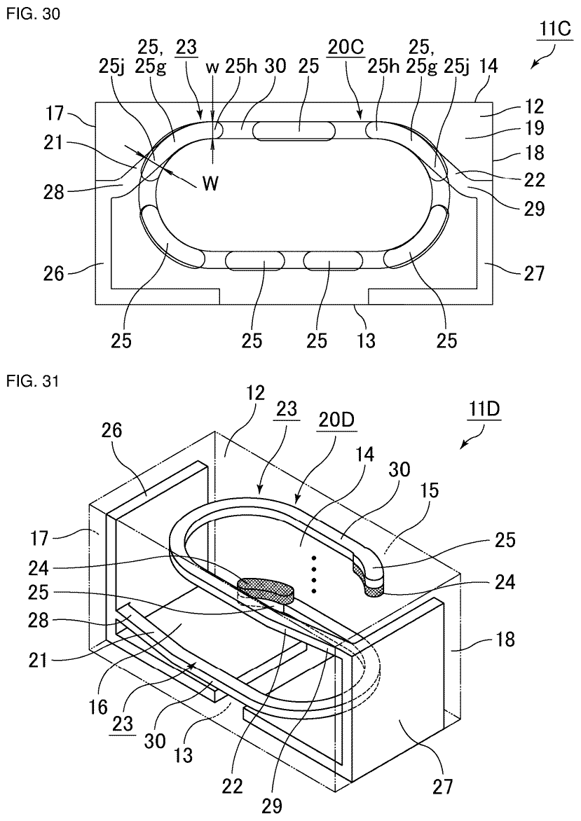

Next, with reference to FIG. 29 and FIG. 30, an inductor 11B and an inductor 11C according to a third embodiment of the present disclosure is described. FIG. 29 and FIG. 30 correspond to FIG. 2. In FIG. 29 and FIG. 30, components corresponding to those depicted in FIG. 2 are provided with the same reference characters and redundant description is omitted.

In the inductor 11B depicted in FIG. 29 and the inductor 11C depicted in FIG. 30, the longitudinal pad portions 25 include a non-uniform pad portion 25g with a non-uniform width-direction dimension. That is, the width-direction dimension of the non-uniform pad portion 25g varies depending on the position in a direction in which the relevant line conductor 23 extends.

More specifically, the width-direction dimension of the non-uniform pad portion 25g changes from a relatively small dimension to a relatively large dimension in the direction in which the relevant line conductor 23 extends. Note that the relevant line conductor 23 herein means the line conductor 23 having this non-uniform pad portion 25g.

Also, as depicted in FIG. 29 and FIG. 30, a maximum value W of the width-direction dimension of the non-uniform pad portion 25g is larger than the width-direction dimension of the line wire portion 30, and a minimum value w of the width-direction dimension of the non-uniform pad portion 25g is larger than or equal to the width-direction dimension of the line wire portion 30. Note that in FIG. 29 and FIG. 30, a state is depicted in which the minimum value w of the width-direction dimension of the non-uniform pad portion 25g is equal to the width-direction dimension of the line wire portion 30.

Also, as depicted in FIG. 29 and FIG. 30, of the non-uniform pad portion 25g, the center position in the width direction of a portion having a width-direction dimension larger than the width-direction dimension of the line wire portion 30 is shifted from the center position of the line wire portion in the width direction to the outer circumferential side of the helical path. With this, as with the first embodiment, influences of blocking the magnetic flux passing through the inside of a coil 20B and a coil 20C can be made small, and it is thus possible to suppress degradation in Q characteristics and improve the Q characteristics. Also, in an area not contributing to an increase in internal stress, the width-direction dimension of the longitudinal pad portion 25 can be expanded, and connection reliability can be kept. Furthermore, blocking of the magnetic flux passing through the inside of the coil by the longitudinal pad portion 25 can be suppressed to minimum. Therefore, it is possible to obtain high reliability with an increase in internal stress being suppressed and obtain high Q characteristics with blocking of the magnetic flux passing through the inside of the coil by the longitudinal pad portion 25 being suppressed to minimum.

In the inductor 11B depicted in FIG. 29, as with the first embodiment, when a shortest distance between the corner portion 31 oriented to a line wire portion 30 side of the first outer terminal electrode 26 or the second outer terminal electrode 27 and the outer circumferential edge of the line wire portion 30 is taken as d when seen through to the axial direction of the coil 20, the non-uniform pad portion 25g has a first portion in which the space dl from the inner end surface of the first outer terminal electrode 26 or the second outer terminal electrode 27 or the surface of the component main body 12 is smaller than or equal to d and a second portion in which the space d2 from the inner end surface of the first outer terminal electrode 26 or the second outer terminal electrode 27 or the surface of the component main body 12 is larger than d. And, as depicted in FIG. 29, the width-direction dimension of the first portion (portion with the space d1) is smaller than the width-direction dimension of the second portion (portion with the space d2). With this, it is possible to suppress an increase in internal stress between the line conductors 23 opposed to the first outer terminal electrode 26 and the second outer terminal electrode 27 where internal stress particularly concentrate and an increase in internal stress at a location where the surface of the component main body 12, to which external impact is directly applied, and the line conductor 23 are adjacent to each other.

Note that the space d1 or d2 between the first portion or the second portion and the inner end surface of the first outer terminal electrode 26 or the second outer terminal electrode 27 or the surface of the component main body 12 means a space between the outer circumferential edge of the first portion or the second portion and the inner end surface of the first outer terminal electrode 26 or the second outer terminal electrode 27 or the surface of the component main body 12.

Also, when the distance d1 between the first portion and the inner end surface of the first outer terminal electrode 26 or the second outer terminal electrode 27 or the surface of the component main body 12 is equal to d, this means a case in which that distance is within a range of d±3% (including boundary values).

Also, when the space d1 or d2 between the first portion or the second portion and the inner end surface of the first outer terminal electrode 26 or the second outer terminal electrode 27 or the surface of the component main body 12 is smaller or larger than d, this means a case in which that space is below or exceeds the range of d±3%.

In the inductor 11C depicted in FIG. 30, the coil 20C has two curved portions respectively opposed to the first end surface 17 and the second end surface 18 of the component main body 12 and a linear portion opposed to the top surface 14 of the component main body 12. In this manner, the coil 20C has curved portions to a major-axis direction (longitudinal direction) of the component main body 12. More specifically, the coil 20C has an oval shape when seen through to the axial direction of the coil 20.

Also, as depicted in FIG. 30, of the non-uniform pad portion 25g, the width-direction dimension of a portion 25h opposed to the top surface 14 of the component main body 12 in parallel is smaller than the width-direction dimension of a portion 25j not opposed to the top surface 14 in parallel. Also with this, it is possible to suppress an increase in internal stress between the line conductors 23 opposed to the first outer terminal electrode 26 and the second outer terminal electrode 27 where internal stress particularly concentrate and an increase in internal stress at a location where the surface of the component main body 12, to which external impact is directly applied, and the line conductor 23 are adjacent to each other.

Note that in the inductor 11B depicted in FIG. 29 and the inductor 11C depicted in FIG. 30, as with the first and second embodiments, the longitudinal pad portions 25 include a uniform pad portion with a uniform width-direction dimension, but this uniform pad portion does not have to be provided in the present embodiment.

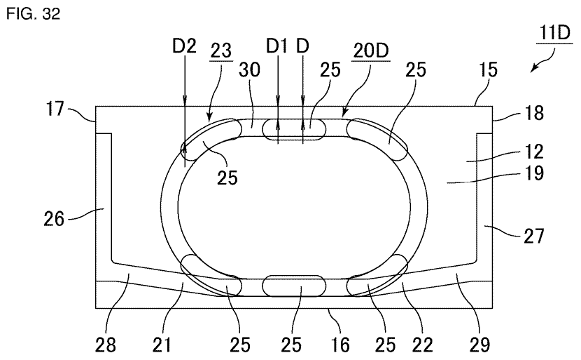

Next, with reference to FIG. 31 and FIG. 32, an inductor 11D according to a fourth embodiment of the present disclosure is described. In FIG. 31, depiction of line conductors and longitudinal via conductors positioned between the line conductor 23 and the longitudinal via conductor 24 positioned closest to a mount surface 13 side and the line conductor 23 and the longitudinal via conductor 24 positioned closest to a top surface 14 side is omitted. FIG. 32 corresponds to FIG. 2. In FIG. 31 and FIG. 32, components corresponding to those depicted in FIG. 1 and FIG. 2 are provided with the same reference characters and redundant description is omitted.

In the inductor 11D depicted in FIG. 31 and FIG. 32, as with the first embodiment, the width-direction dimension of each longitudinal pad portion 25 is made larger than the width-direction dimension of the line wire portion 30. However, in the inductor 11D, the axial line of the coil 20D is oriented to a direction orthogonal to the mount surface 13 and the top surface 14.

Also, as depicted in FIG. 32, when a shortest distance between the surface of the component main body 12 and the outer circumferential edge of the line wire portion 30 is set as D, of the longitudinal pad portion 25, the center position in the width direction of a portion where a space D1 from the inner end surface of the first outer terminal electrode 26 or the second outer terminal electrode 27 or the surface of the component main body 12 is smaller than or equal to D is shifted from the center position of the line wire portion 30 in the width direction to the inner circumferential side of the helical path, and, of the longitudinal pad portion 25, the center position in the width direction of a portion where a space D2 from the inner end surface of the first outer terminal electrode 26 or the second outer terminal electrode 27 or the surface of the component main body 12 is larger than D is shifted from the center position of the line wire portion 30 in the width direction to the outer circumferential side of the helical path. With this, as with the first embodiment, influences of blocking the magnetic flux passing through the inside of the coil 20D can be made small, and it is thus possible to suppress degradation in Q characteristics and improve the Q characteristics. Also, it is possible to obtain high reliability with an increase in internal stress being suppressed and obtain high Q characteristics with blocking of the magnetic flux passing through the inside of the coil by the longitudinal pad portion 25 being suppressed to minimum.

Note that while the surface of the component main body 12 for which the shortest distance D is calculated is not limited, a distance between the first side surface 15 or the second side surface 16 of the component main body 12 and the outer circumferential edge of the line wire portion 30 is normally set as the shortest distance D in the present embodiment.

Also, the space D1 or D2 between a portion where the longitudinal pad portion 25 is present and the inner end surface of the first outer terminal electrode 26 or the second outer terminal electrode 27 or the surface of the component main body 12 means a space between the outer circumferential edge of that portion and the inner end surface of the first outer terminal electrode 26 or the second outer terminal electrode 27 or the surface of the component main body 12.

Also, when the distance D1 between the portion where the longitudinal pad portion 25 is present and the inner end surface of the first outer terminal electrode 26 or the second outer terminal electrode 27 or the surface of the component main body 12 is equal to D, this means a case in which that space is within a range of D±3% (including boundary values).

Also, when the space D1 or D2 between the portion where the longitudinal pad portion 25 is present and the inner end surface of the first outer terminal electrode 26 or the second outer terminal electrode 27 or the surface of the component main body 12 is smaller or larger than D, this means a case in which that space is below or exceeds the range of D±3%.

The inductor according to the first to fourth embodiments is manufactured by, for example, the following method.

### Process of Manufacturing a Mother Multilayer Body

First, for example, coating with insulation paste containing a glass material or the like having a borosilicate glass as a main component is repeated by screen printing or the like to form an insulation paste layer. The insulation paste layer formed herein later becomes the non-conductive material layer 19 that gives the first side surface 15 of the component main body 12.

Next, for example, coating with photosensitive conductive paste having Ag or the like as a metal main component is performed by screen printing or the like, thereby forming a photosensitive conductive paste layer on the insulation paste layer. Furthermore, after the photosensitive conductive paste layer is irradiated with ultraviolet rays or the like via a photomask, development is performed with alkaline solution or the like, thereby forming a line conductor layer, an outer conductor layer, and an extended conductor layer connected to the line conductor layer and the outer conductor layer on the insulation paste layer. In the manner as described above, the line conductor layer, the extended conductor layer, and the outer conductor layer are formed at a plurality of locations by photolithography. The line conductor layer formed herein later becomes the line conductor 23 positioned closest to a first side surface 15 side. The extended conductor layer formed herein later becomes the first extended conductor 28. The outer conductor layer formed herein later becomes part of each of the first extended conductor 28 and the second extended conductor 29.

When the line conductor layer is formed, for example, by using a photomask where the pattern of the line conductor according to the inductor of the present disclosure (for example, the pattern of the line conductor depicted in FIG. 3 to FIG. 25) is written, it is possible to achieve, in an inductor obtained later, the pattern of the line conductor according to the inductor of the present disclosure.

Note that when the line conductor layer, the extended conductor layer, and the outer conductor layer are formed, in place of exposure using a photomask, for example, DI exposure not using a photomask (which is called direct image exposure or direct writing) may be performed.

Next, for example, coating with photosensitive insulation paste is performed by screen printing or the like, thereby forming a new insulation paste layer on the already-formed insulation paste layer. Furthermore, after the newly-formed insulation paste layer is irradiated with ultraviolet rays or the like via a photomask, development is performed with alkaline solution or the like, thereby forming via holes and openings in the insulation paste layer. In the manner as described above, the insulation paste layer provided with via holes and openings at a plurality of locations is formed by photolithography. The insulation paste layer formed herein includes an insulation paste layer that later becomes the non-conductive material layer 19 (however, except the non-conductive material layer 19 giving the first side surface 15 of the component main body 12 and the non-conductive material layer 19 giving the second side surface 16 of the component main body 12). The via holes formed herein overlap part of the already-formed line conductor layer. The openings formed herein overlap the already-formed outer conductor layer.

Note that when the insulation paste layer provided with via holes and openings is formed, in place of exposure using a photomask, for example, DI exposure not using a photomask may be performed.

Next, for example, coating with photosensitive conductive paste having Ag or the like as a metal main component is performed by screen printing or the like, thereby forming a new photosensitive conductive paste layer inside the via holes and the openings on the already-formed insulation paste layer. Furthermore, after the photosensitive conductive paste layer is irradiated with ultraviolet rays or the like via a photomask, development is performed with alkaline solution or the like, thereby forming a via conductor layer inside the via holes and forming a new line conductor layer connected to the via conductor layer on the insulation paste layer and, still further, forming a new outer conductor layer connected to the already-formed outer conductor layer inside the openings and forming another new outer conductor layer on this outer conductor layer. In the manner as described above, the line conductor layers, the via conductor layers, and the outer conductor layers are formed by photolithography. The via conductor layer formed herein later becomes a via conductor connecting line conductors adjacent to each other to the coil-axis direction.

Note that when the line conductor layers, the via conductor layers, and the outer conductor layers are formed, in place of exposure using a photomask, for example, DI exposure not using a photomask may be performed.

Then, by repeating the above-described process, the insulation paste layers, the line conductor layers, the via conductor layers, and the outer conductor layers are formed so as to have a predetermined multilayer structure. For example, the line conductor layers formed herein include a line conductor layer that later becomes the line conductor 23 positioned closest to a second side surface 16 side.

Note that when the line conductor layer that later becomes the line conductor 23 positioned closest to the second side surface 16 side and the outer conductor layer of the same layer as that line conductor layer are formed, an extended conductor layer connected to the line conductor layer and the outer conductor layer is also formed. The extended conductor layer formed herein later becomes the second extended conductor 29.

Lastly, for example, coating with insulation paste containing a glass material or the like having a borosilicate glass as a main component is repeated by screen printing or the like, thereby forming a new insulation paste layer. The insulation paste layer formed herein later becomes the non-conductive material layer 19 that gives the second side surface 16 of the component main body 12.

The mother multilayer body is fabricated in the above-described manner.

The method of forming each conductor pattern of a line conductor layer, an extended conductor layer, a via conductor layer, and an outer conductor layer is not limited to photolithography described above. For example, the method may be a method of printing and stacking conductive paste by using a screen printing plate provided with an opening in the shape of the conductor pattern; a method of forming a conductive film by sputtering, vapor deposition, a foil pressure-bonding method, or the like and then etching the conductive film into the shape of the conductor pattern; or a method of forming a negative pattern by semi-additive process to form a plating film and then removing an unwanted portion of the plating film by etching or the like so as to form the shape of the conductor pattern.

When each conductor pattern of the line conductor layer, the extended conductor layer, the via conductor layer, and the outer conductor layer is formed, conductor patterns are formed in a multistage manner to achieve a high aspect ratio, and thus a loss due to resistance at high frequencies can be reduced. The method of multistage formation of conductive patterns is not particularly limited, and may be, for example, a method of repeatedly stacking conductive patterns by repeating the process of using photolithography as described above; a method of repeatedly stacking conductive patterns formed by semi-additive process; a method of stacking, in random order, conductive patterns formed by semi-additive process and conductive patterns formed by etching a separately-grown plating film; or a method of further growing a plating film formed by semi-additive process.

The conductive material configuring the conductor patterns of the line conductor layer, the extended conductor layer, the via conductor layer, and the outer conductor layer is not limited to the above-described photosensitive conductive paste having Ag or the like as a metal main component, but may be a conductor containing a metal such as Ag, Au, or Cu formed by, for example, sputtering, vapor deposition, a foil pressure-bonding method, a plating method, or the like.

The method of forming the insulation paste layer is not limited to photolithography described above, but may be, for example, a method of pressure-bonding a sheet made of an insulating material; a method of spin-coating an insulating material; or a method of spray-coating an insulating material.

The method of forming an insulation paste layer provided with via holes and openings is not limited to photolithography described above, but may be, for example, a method in which an insulation film is formed by a method of pressure-bonding a sheet made of an insulating material, spin-coating an insulating material, spray-coating an insulating material, or the like, and laser process, drill process, or the like is then performed on the insulation film to provide via holes and openings.

The insulating material configuring an insulation paste layer is not limited to the above-described glass material having a borosilicate glass as a main component, but may be, for example, an organic material such as a ceramics material, epoxy resin, fluororesin, polymer resin, or the like; a composite material such as glass epoxy resin; or the like. As the insulating material, a material with small permittivity and small dielectric loss is particularly suitable.

### Process of Forming an Element Body, a Coil, and Outer Terminal Electrodes

First, a mother multilayer body is cut with a dicing machine or the like to be separated into individual pieces of a plurality of non-fired multilayer bodies.

The non-fired multilayer bodies each have an insulation paste multilayer portion formed with stacked insulation paste layers, a line conductor multilayer portion formed with stacked line conductor layers so that line conductor layers adjacent to each other are electrically connected via a via conductor layer, and an outer conductor multilayer portion formed with stacked outer conductor layers.

When the multilayer body is separated into individual pieces of non-fired multilayer bodies, the outer conductor multilayer portion is exposed at two locations at least on the bottom surface of the insulation paste multilayer portion included in a cut surface of the non-fired multilayer body.

Next, the non-fired multilayer bodies are fired to fabricate a multilayer body.

When the non-fired multilayer bodies are fired, the insulation paste layer becomes a non-conductive material layer as an insulation layer, and thus the insulation paste multilayer portion becomes the component main body 12 (element body). Also, when the non-fired multilayer bodies are fired, the line conductor layer becomes a line conductor, and therefore the line conductor multilayer portion becomes a coil. Furthermore, when the non-fired multilayer bodies are fired, one of two outer conductor multilayer portions becomes part of the first outer terminal electrode 26 and the other becomes part of the second outer terminal electrode 27.

Next, the corner portions and the edge-line portions of the component main body 12 may be rounded by performing, for example, barrel polishing on the obtained multilayer body.

Lastly, with two outer conductor multilayer portions after firing being taken as base electrodes, a Ni-plated electrode and a Sn-plated electrode are sequentially formed on the surface of each base electrode by plating. The thickness of the Ni-plated electrode and the thickness of the Sn-plated electrode are each set to be, for example, 2 μm or more and 10 μm or less (i.e., from 2 μm to 10 μm).

In this manner, the first outer terminal electrode 26 and the second outer terminal electrode 27 each having a base electrode, a Ni-plated electrode, and a Sn-plated electrode sequentially from a surface side of the element body 10 are formed.

The method of forming outer terminal electrodes is not limited to the above-described method of performing plating on the outer conductor multilayer portion exposed to the cut surface of the non-fired multilayer body (at least the bottom surface of the insulation paste multilayer portion), but may be, for example, a method in which, after the outer conductor multilayer portion is exposed to the cut surface of the non-fired multilayer body (at least the bottom surface of the insulation paste multilayer portion) as described above, the exposed portion of the outer conductor multilayer portion is immersed (dipped) in conductive paste or a conductive paste film is formed by sputtering on the exposed portion of the outer conductor multilayer portion, and then plating is performed.

The inductor according to the first to fourth embodiments is manufactured in the above-described manner.

The inductor according to the first to fourth embodiments is manufactured so as to have, for example, a 0402 (0.4 mm×0.2 mm×0.2 mm) size. The size of the inductor according to the first to fourth embodiments is not limited to the 0402 (0.4 mm×0.2 mm×0.2 mm) size.

As described above, as a form for use to form a line conductor layer (line conductor later), a photomask (for example, when exposure by photolithography is performed), a design drawing (when DI exposure is performed), or the like can be thought. When the pattern of a line conductor (for example, the pattern of the line conductor depicted in FIG. 3 to FIG. 25) according to the inductor of the present disclosure is written in any of these forms, the pattern of the line conductor according to the inductor of the present disclosure can be achieved. Thus, a form (for example, a photomask, a design drawing, or the like) having the pattern of the line conductor according to the inductor of the present disclosure written is also one aspect of the present disclosure.

In the specification, the following details are disclosed.
<1> An inductor including a component main body having a multilayer structure formed with a plurality of stacked non-conductive material layers; and a coil arranged inside the component main body and configured of a plurality of line conductors each extending along an interface between the non-conductive material layers and a plurality of via conductors penetrating through the non-conductive material layers to a thickness direction. The line conductors each have pad portions connected to the via conductors and line wire portions connected to the pad portions. The coil has a shape of extending along a helical path with the line conductors and the via conductors alternately connected, in which the via conductors include a longitudinal via conductor in a longitudinal shape extending along said line conductor, the pad portions include a longitudinal pad portion connected to the longitudinal via conductor, a width-direction dimension of the longitudinal pad portion is larger than a width-direction dimension of said line wire portion, and when seen through to an axial direction of the coil, a center position of the longitudinal pad portion in a width direction is shifted from a center position of the line wire portion in the width direction to at least one of an inner circumferential side and an outer circumferential side of the helical path
<2> The inductor according to <1>, further including an outer terminal electrode provided so as to be exposed from an outer surface of the component main body and connected to any end of the coil. When seen through to the axial direction of the coil, of the longitudinal pad portion, a center position in the width direction of at least a portion most adjacent to the outer terminal electrode is shifted from the center position of the line wire portion in the width direction to the inner circumferential side of the helical path.
<3> The inductor according to <1> or <2>, in which when seen through to the axial direction of the coil, of the longitudinal pad portion, a center position in the width direction of at least a portion most adjacent to a surface of the component main body is shifted from the center position of the line wire portion in the width direction to the inner circumferential side of the helical path.
<4> The inductor according to any one of <1> to <3>, in which when seen through to the axial direction of the coil, the longitudinal pad portion includes a plurality of longitudinal pad portions with different directions of being shifted from the center position of the line wire portion in the width direction.
<5> The inductor according to any one of <1> to <4>, in which when seen through to the axial direction of the coil, the longitudinal pad portion includes longitudinal pad portions with different directions of being shifted from the center position of the line wire portion in the width direction depending on a position in a direction in which the line conductor extends.
<6> The inductor according to any one of <1> to <5>, further including an outer terminal electrode provided so as to be exposed from an outer surface of the component main body and connected to any end of the coil. When a shortest distance between a corner portion of the outer terminal electrode oriented to a line wire portion side and an outer circumferential edge of the line wire portion is set as d when seen through to the axial direction of the coil, the line wire portion has a first area in which a space from an inner end surface of the outer terminal electrode or a surface of the component main body is smaller than or equal to d and a second area in which a space from the inner end surface of the outer terminal electrode or the surface of the component main body is larger than d, when seen through to the axial direction of the coil, of the longitudinal pad portion, a center position in the width direction of a portion overlapping the first area is shifted from a center position of the first area in the width direction to the inner circumferential side of the helical path, and when seen through to the axial direction of the coil, of the longitudinal pad portion, a center position in the width direction of a portion overlapping the second area is shifted from a center position of the second area in the width direction to the outer circumferential side of the helical path.
<7> The inductor according to <6>, in which d is 10 μm or more.
<8> The inductor according to any one of <1> to <7>, in which the longitudinal pad portion has a first portion in which a center position in the width direction is shifted from the center position of the line wire portion in the width direction to the inner circumferential side of the helical path and a second portion in which a center position in the width direction is shifted from the center position of the line wire portion in the width direction to the outer circumferential side of the helical path. When seen through to the axial direction of the coil, a space between an area of the line wire portion overlapping the first portion and an inner end surface of the outer terminal electrode or a surface of the component main body is smaller than a space between an area of the line wire portion overlapping the second portion and the inner end surface of the outer terminal electrode or the surface of the component main body.
<9> The inductor according to any one of <1> to <5>, in which the component main body has a rectangular-parallelepiped shape and has a mount surface, a top surface opposed to the mount surface, a first side surface and a second side surface coupling the mount surface and the top surface together and opposed to each other, and a first end surface and a second end surface coupling the mount surface and the top surface together and coupling the first side surface and the second side surface together and opposed to each other. The coil has a curved portion opposed to the first end surface or the second end surface of the component main body and a linear portion opposed to the top surface. Also, of the longitudinal pad portion, a center position in the width direction of at least part opposed to the top surface in parallel is shifted from the center position of the line wire portion in the width direction to the inner circumferential side of the helical path, and of the longitudinal pad portion, a center position in the width direction of at least part not opposed to the top surface in parallel is shifted from the center position of the line wire portion in the width direction to the outer circumferential side of the helical path.
<10> An inductor including a component main body having a multilayer structure formed with a plurality of stacked non-conductive material layers; and a coil arranged inside the component main body and configured of a plurality of line conductors each extending along an interface between the non-conductive material layers and a plurality of via conductors penetrating through the non-conductive material layers to a thickness direction. The line conductors each have pad portions connected to the via conductors and line wire portions connected to the pad portions. The coil has a shape of extending along a helical path with the line conductors and the via conductors alternately connected, in which the via conductors include a longitudinal via conductor in a longitudinal shape extending along said line conductor, the pad portions include a longitudinal pad portion connected to the longitudinal via conductor, the longitudinal pad portion includes a non-uniform pad portion with a non-uniform width-direction dimension, a maximum value of the width-direction dimension of the non-uniform pad portion is larger than a width-direction dimension of said line wire portion, a minimum value of the width-direction dimension of the non-uniform pad portion is larger than or equal to the width-direction dimension of the line wire portion, and of the non-uniform pad portion, a center position in a width direction of a portion having a width-direction dimension larger than the width-direction dimension of the line wire portion is shifted from a center position of the line wire portion in the width direction to an outer circumferential side of the helical path.
<11> The inductor according to <10>, further including an outer terminal electrode provided so as to be exposed from an outer surface of the component main body and connected to any end of the coil. When a shortest distance between a corner portion of the outer terminal electrode oriented to a line wire portion side and an outer circumferential edge of the line wire portion is set as d when seen through to an axial direction of the coil, the non-uniform pad portion has a first portion in which a space from an inner end surface of the outer terminal electrode or a surface of the component main body is smaller than or equal to d, and a second portion in which a space from the inner end surface of the outer terminal electrode or the surface of the component main body is larger than d, and a width-direction dimension of the first portion is smaller than a width-direction dimension of the second portion.
<12> The inductor according to <10>, in which the component main body has a rectangular-parallelepiped shape and has a mount surface, a top surface opposed to the mount surface, a first side surface and a second side surface coupling the mount surface and the top surface together and opposed to each other, and a first end surface and a second end surface coupling the mount surface and the top surface together and coupling the first side surface and the second side surface together and opposed to each other. The coil has a curved portion opposed to the first end surface or the second end surface of the component main body and a linear portion opposed to the top surface, and of the non-uniform pad portion, a width-direction dimension of a portion opposed to the top surface in parallel is smaller than a width-direction dimension of a portion not opposed to the top surface in parallel.
<13> An inductor including a component main body having a multilayer structure formed with a plurality of stacked non-conductive material layers; a coil arranged inside the component main body and configured of a plurality of line conductors each extending along an interface between the non-conductive material layers and a plurality of via conductors penetrating through the non-conductive material layers to a thickness direction, the line conductors each having pad portions connected to the via conductors and line wire portions connected to the pad portions, the coil having a shape of extending along a helical path with the line conductors and the via conductors alternately connected; and an outer terminal electrode provided so as to be exposed from an outer surface of the component main body and connected to any end of the coil. The via conductors include a longitudinal via conductor in a longitudinal shape extending along said line conductor, the pad portions include a longitudinal pad portion connected to the longitudinal via conductor, the component main body has a rectangular-parallelepiped shape and has a mount surface, a top surface opposed to the mount surface, a first side surface and a second side surface coupling the mount surface and the top surface together and opposed to each other, and a first end surface and a second end surface coupling the mount surface and the top surface together and coupling the first side surface and the second side surface together and opposed to each other. An axial line of the coil is oriented to a direction orthogonal to the mount surface, and a width-direction dimension of the longitudinal pad portion is larger than a width-direction dimension of said line wire portion. Also, when a shortest distance between a surface of the component main body and an outer circumferential edge of the line wire portion is set as D, of the longitudinal pad portion, a center position in a width direction of a portion in which a space from an inner end surface of the outer terminal electrode or the surface of the component main body is smaller than or equal to D is shifted from a center position of the line wire portion in the width direction to an inner circumferential side of the helical path, and of the longitudinal pad portion, a center position in the width direction of a portion in which the space from the inner end surface of the outer terminal electrode or the surface of the component main body is larger than D is shifted from the center position of the line wire portion in the width direction to an outer circumferential side of the helical path.
<14> An inductor including a component main body having a multilayer structure formed with a plurality of stacked non-conductive material layers; and a coil arranged inside the component main body and configured of a plurality of line conductors each extending along an interface between the non-conductive material layers and a plurality of via conductors penetrating through the non-conductive material layers to a thickness direction. The line conductors each have pad portions connected to the via conductors and line wire portions connected to the pad portions, and the coil has a shape of extending along a helical path with the line conductors and the via conductors alternately connected. The via conductors include a longitudinal via conductor in a longitudinal shape extending along said line conductor, the pad portions include a longitudinal pad portion connected to the longitudinal via conductor, a width-direction dimension of the longitudinal pad portion is larger than a width-direction dimension of said line wire portion, the line wire portion includes a line-symmetric line wire portion having a line-symmetric shape, and the longitudinal pad portion connected to the line-symmetric line wire portion includes a third portion and a fourth portion sequentially arranged to a direction in which the line conductor extends. Also, when a portion obtained by folding the line-symmetric line wire portion along a symmetry axis to the third portion and the fourth portion is set as a virtual line wire portion, an inner circumferential edge of the third portion is positioned on an inner circumferential edge of the virtual line wire portion, an outer circumferential edge of the third portion protrudes from an outer circumferential edge of the virtual line wire portion, an inner circumferential edge of the fourth portion protrudes from the inner circumferential edge of the virtual line wire portion, and an outer circumferential edge of the fourth portion is positioned on the outer circumferential edge of the virtual line wire portion.
<15> The inductor according to any one of <1> to <14>, in which a width-direction dimension of the longitudinal via conductor is larger than the width-direction dimension of the line wire portion.
<16> The inductor according to any one of <1> to <14>, in which a width-direction dimension of the longitudinal via conductor is smaller than the width-direction dimension of the line wire portion, and when seen through to the axial direction of the coil, the longitudinal via conductor does not protrude from the helical path.

What is claimed is:

1. An inductor comprising:
a component main body having a multilayer structure including a plurality of non-conductive material layers; and
a coil inside the component main body and configured of a plurality of line conductors each extending along an interface between the non-conductive material layers and a plurality of via conductors penetrating through the non-conductive material layers in a thickness direction, the line conductors each having pad portions connected to the via conductors and line wire portions connected to the pad portions, and the coil having a shape of extending along a helical path with the line conductors and the via conductors alternately connected, wherein
the via conductors include a longitudinal via conductor in a longitudinal shape extending along the line conductor,
the pad portions include a longitudinal pad portion connected to the longitudinal via conductor,
a width-direction dimension of the longitudinal pad portion is larger than a width-direction dimension of said line wire portion, and
when viewed through to an axial direction of the coil, a center position of the longitudinal pad portion in a width direction is shifted from a center position of the line wire portion in the width direction to at least one of an inner circumferential side and an outer circumferential side of the helical path.

2. The inductor according to claim 1, further comprising:
an outer terminal electrode exposed from an outer surface of the component main body and connected to any end of the coil, wherein
when viewed through to the axial direction of the coil, a center position in the width direction of at least a portion of the longitudinal pad portion which is most adjacent to the outer terminal electrode is shifted from the center position of the line wire portion in the width direction to the inner circumferential side of the helical path.

3. The inductor according to claim 1, wherein
when viewed through to the axial direction of the coil, a center position in the width direction of at least a portion of the longitudinal pad portion which is most adjacent to a surface of the component main body is shifted from the center position of the line wire portion in the width direction to the inner circumferential side of the helical path.

4. The inductor according to claim 1, wherein
when viewed through to the axial direction of the coil, the longitudinal pad portion includes a plurality of longitudinal pad portions being shifted with different directions from the center position of the line wire portion in the width direction.

5. The inductor according to claim 1, wherein
when viewed through to the axial direction of the coil, the longitudinal pad portion includes longitudinal pad portions with different directions of being shifted from the center position of the line wire portion in the width direction depending on a position in a direction in which the line conductor extends.

6. The inductor according to claim 1, further comprising:
an outer terminal electrode exposed from an outer surface of the component main body and connected to any end of the coil, wherein
when a shortest distance between a corner portion of the outer terminal electrode facing a line wire portion side and an outer circumferential edge of the line wire portion is defined when viewed through to the axial direction of the coil,
the line wire portion includes
a first area in which a space between the line wire portion and an inner end surface of the outer terminal electrode or a surface of the component main body is smaller than or equal to the shortest distance, and
a second area in which a space between the line wire portion and the inner end surface of the outer terminal electrode or the surface of the component main body is larger than the shortest distance,
when viewed through to the axial direction of the coil, a center position in the width direction of a portion of the longitudinal pad portion which overlaps the first area is shifted from a center position of the first area in the width direction to the inner circumferential side of the helical path, and
when viewed through to the axial direction of the coil, a center position in the width direction of a portion of the longitudinal pad portion which overlaps the second area is shifted from a center position of the second area in the width direction to the outer circumferential side of the helical path.

7. The inductor according to claim 6, wherein
the shortest distance is 10 μm or more.

8. The inductor according to claim 1, wherein
the longitudinal pad portion includes
a first portion in which a center position of the longitudinal pad portion in the width direction is shifted from the center position of the line wire portion in the width direction to the inner circumferential side of the helical path, and
a second portion in which a center position of the longitudinal pad portion in the width direction is shifted from the center position of the line wire portion in the width direction to the outer circumferential side of the helical path, and
when viewed through to the axial direction of the coil, a space between an area of the line wire portion overlapping the first portion and an inner end surface of the outer terminal electrode or a surface of the component main body is smaller than a space between an area of the line wire portion overlapping the second portion and the inner end surface of the outer terminal electrode or the surface of the component main body.

9. The inductor according to claim 1, wherein
the component main body has a rectangular-parallelepiped shape and has a mount surface, a top surface opposed to the mount surface, a first side surface and a second side surface connecting the mount surface and the top surface together and opposed to each other, and a first end surface and a second end surface connecting the mount surface and the top surface together and connecting the first side surface and the second side surface together and opposed to each other,
the coil has a curved portion opposed to the first end surface or the second end surface of the component main body and a linear portion opposed to the top surface,
a center position in the width direction of at least a portion of the longitudinal pad portion which is opposed to the top surface in parallel is shifted from the center position of the line wire portion in the width direction to the inner circumferential side of the helical path, and
a center position in the width direction of at least a portion of the longitudinal pad portion which is not opposed to the top surface in parallel is shifted from the center position of the line wire portion in the width direction to the outer circumferential side of the helical path.

10. An inductor comprising:
a component main body having a multilayer structure including a plurality of stacked non-conductive material layers; and
a coil inside the component main body and configured of a plurality of line conductors each extending along an interface between the non-conductive material layers and a plurality of via conductors penetrating through the non-conductive material layers to a thickness direction, the line conductors each having pad portions connected to the via conductors and line wire portions connected to the pad portions, the coil having a shape of extending along a helical path with the line conductors and the via conductors alternately connected, wherein
the via conductors include a longitudinal via conductor in a longitudinal shape extending along the line conductor,
the pad portions include a longitudinal pad portion connected to the longitudinal via conductor,
the longitudinal pad portion includes a non-uniform pad portion with a non-uniform width-direction dimension,
a maximum value of the width-direction dimension of the non-uniform pad portion is larger than a width-direction dimension of the line wire portion,
a minimum value of the width-direction dimension of the non-uniform pad portion is larger than or equal to the width-direction dimension of the line wire portion, and
a center position in a width direction of a portion of the non-uniform pad portion which has a width-direction dimension larger than the width-direction dimension of the line wire portion is shifted from a center position of the line wire portion in the width direction to an outer circumferential side of the helical path.

11. The inductor according to claim 10, further comprising:
an outer terminal electrode exposed from an outer surface of the component main body and connected to any end of the coil, wherein
when a shortest distance between a corner portion of the outer terminal electrode facing a line wire portion side and an outer circumferential edge of the line wire portion is defined when viewed through to an axial direction of the coil,
the non-uniform pad portion has
a first portion in which a space between the non-uniform pad portion and an inner end surface of the outer terminal electrode or a surface of the component main body is smaller than or equal to the shortest distance, and
a second portion in which a space between the non-uniform pad portion and the inner end surface of the outer terminal electrode or the surface of the component main body is larger than the shortest distance, and
a width-direction dimension of the first portion is smaller than a width-direction dimension of the second portion.

12. The inductor according to claim 10, wherein
the component main body has a rectangular-parallelepiped shape and has a mount surface, a top surface opposed to the mount surface, a first side surface and a second side surface connecting the mount surface and the top surface together and opposed to each other, and a first end surface and a second end surface connecting the mount surface and the top surface together and connecting the first side surface and the second side surface together and opposed to each other,
the coil has a curved portion opposed to the first end surface or the second end surface of the component main body and a linear portion opposed to the top surface, and
a width-direction dimension of a portion of the non-uniform pad portion which is opposed to the top surface in parallel is smaller than a width-direction dimension of a portion of the non-uniform pad portion which is not opposed to the top surface in parallel.

13. An inductor comprising:
a component main body having a multilayer structure including a plurality of stacked non-conductive material layers;
a coil inside the component main body and configured of a plurality of line conductors each extending along an interface between the non-conductive material layers and a plurality of via conductors penetrating through the non-conductive material layers to a thickness direction, the line conductors each having pad portions connected to the via conductors and line wire portions connected to the pad portions, the coil having a shape of extending along a helical path with the line conductors and the via conductors alternately connected; and
an outer terminal electrode provided so as to be exposed from an outer surface of the component main body and connected to any end of the coil, wherein
the via conductors include a longitudinal via conductor in a longitudinal shape extending along the line conductor,
the pad portions include a longitudinal pad portion connected to the longitudinal via conductor,
the component main body has a rectangular-parallelepiped shape and has a mount surface, a top surface opposed to the mount surface, a first side surface and a second side surface connecting the mount surface and the top surface together and opposed to each other, and a first end surface and a second end surface connecting the mount surface and the top surface together and connecting the first side surface and the second side surface together and opposed to each other,
an axial line of the coil is oriented to a direction orthogonal to the mount surface,
a width-direction dimension of the longitudinal pad portion is larger than a width-direction dimension of the line wire portion, and
when a shortest distance between a surface of the component main body and an outer circumferential edge of the line wire portion is defined,
a center position in a width direction of a portion of the longitudinal pad portion, in which a space between the longitudinal pad portion and an inner end surface of the outer terminal electrode or the surface of the component main body is smaller than or equal to the shortest distance, is shifted from a center position of the line wire portion in the width direction to an inner circumferential side of the helical path, and
a center position in the width direction of a portion of the longitudinal pad portion, in which the space between the longitudinal pad portion and the inner end surface of the outer terminal electrode or the surface of the component main body is larger than the shortest distance, is shifted from the center position of the line wire portion in the width direction to an outer circumferential side of the helical path.

14. An inductor comprising:
a component main body having a multilayer structure including a plurality of stacked non-conductive material layers; and
a coil inside the component main body and configured of a plurality of line conductors each extending along an interface between the non-conductive material layers and a plurality of via conductors penetrating through the non-conductive material layers to a thickness direction, the line conductors each having pad portions connected to the via conductors and line wire portions connected to the pad portions, the coil having a shape of extending along a helical path with the line conductors and the via conductors alternately connected, wherein
the via conductors include a longitudinal via conductor in a longitudinal shape extending along the line conductor,
the pad portions include a longitudinal pad portion connected to the longitudinal via conductor,
a width-direction dimension of the longitudinal pad portion is larger than a width-direction dimension of the line wire portion,
the line wire portion includes a line-symmetric line wire portion having a line-symmetric shape,
the longitudinal pad portion connected to the line-symmetric line wire portion includes a third portion and a fourth portion sequentially arranged in a direction in which the line conductor extends, and
when a portion obtained by folding the line-symmetric line wire portion along a symmetry axis to the third portion and the fourth portion is defined as a virtual line wire portion,
an inner circumferential edge of the third portion is positioned on an inner circumferential edge of the virtual line wire portion,
an outer circumferential edge of the third portion protrudes from an outer circumferential edge of the virtual line wire portion,
an inner circumferential edge of the fourth portion protrudes from the inner circumferential edge of the virtual line wire portion, and
an outer circumferential edge of the fourth portion is positioned on the outer circumferential edge of the virtual line wire portion.

15. The inductor according to claim 1, wherein
a width-direction dimension of the longitudinal via conductor is larger than the width-direction dimension of the line wire portion.

16. The inductor according to claim 1, wherein
a width-direction dimension of the longitudinal via conductor is smaller than the width-direction dimension of the line wire portion, and
when viewed through to the axial direction of the coil, the longitudinal via conductor does not protrude from the helical path.

17. The inductor according to claim 2, wherein
when viewed through to the axial direction of the coil, a center position in the width direction of at least a portion of the longitudinal pad portion which is most adjacent to a surface of the component main body is shifted from the center position of the line wire portion in the width direction to the inner circumferential side of the helical path.

18. The inductor according to claim 2, wherein
when viewed through to the axial direction of the coil, the longitudinal pad portion includes a plurality of longitudinal pad portions being shifted with different directions from the center position of the line wire portion in the width direction.

19. The inductor according to claim 2, wherein
when viewed through to the axial direction of the coil, the longitudinal pad portion includes longitudinal pad portions with different directions of being shifted from the center position of the line wire portion in the width direction depending on a position in a direction in which the line conductor extends.

20. The inductor according to claim 2, further comprising:
an outer terminal electrode exposed from an outer surface of the component main body and connected to any end of the coil, wherein
when a shortest distance between a corner portion of the outer terminal electrode facing a line wire portion side and an outer circumferential edge of the line wire portion is defined when viewed through to the axial direction of the coil,
the line wire portion includes
a first area in which a space between the line wire portion and an inner end surface of the outer terminal electrode or a surface of the component main body is smaller than or equal to the shortest distance, and
a second area in which a space between the line wire portion and the inner end surface of the outer terminal electrode or the surface of the component main body is larger than the shortest distance,
when viewed through to the axial direction of the coil, a center position in the width direction of a portion of the longitudinal pad portion which overlaps the first area is shifted from a center position of the first area in the width direction to the inner circumferential side of the helical path, and
when viewed through to the axial direction of the coil, a center position in the width direction of a portion of the longitudinal pad portion which overlaps the second area is shifted from a center position of the second area in the width direction to the outer circumferential side of the helical path.
